(19) United States
(12) Patent Application Publication
(10) Pub. No.: US 2010/0096443 A1
(43) Pub. Date: Apr. 22, 2010

(54) System and Method of Information Management for Use with Musical and Theatrical Entertainment

(76) Inventor: Christopher D. Maloney, Lake Forest, IL (US)

Correspondence Address: LOEB & LOEB, LLP, 321 NORTH CLARK, SUITE 2300, CHICAGO, IL, 60654-4746, US

(21) Appl. No.: 12/170,958

(22) Filed: Jul. 10, 2008

(51) Int. Cl. G06F 17/00

(52) U.S. Cl. 235/375

(57) ABSTRACT

An information system for use in information management for musical and theatrical entertainment comprising an electronically-accessible data record. The information system includes a performance element; a substrate having thereon one or more printed codes practically imperceptible to a human being; and a device having an optical reader capable of reading a selected one of the one or more printed codes on the substrate, non-volatile memory and a controller, the device further having means for providing humanly perceptible feedback, the non-volatile memory storing the performance element.

### STATEMENT OF RELATED CASES

The present disclosure is a continuation-in-part of U.S. patent application Ser. No. 12/141,030 filed on Jun. 17, 2008.

### BACKGROUND OF THE INVENTION

1. Field of the Invention

This invention relates in general to information management and in particular to a system for integrating physical articles with recorded information.

2. Description of the Related Art

Related systems are known in the prior art, especially in the area of children books and educational books. Specifically other systems have disclosed encoding techniques and similar techniques wherein there is invisible code embedded under visible indicia.

For example, U.S. Pat. No. 7,350,718 discloses a document, with indexes and associated document reader. The document is constructed by printing plural pixels and divided into plural areas. Each of the areas has plural indexes respectively consisting of a group of indexing dots to represent an area code corresponding to the area. The document is read according to the different optical reflection features of the pixels which are filter, recognized by a pattern sensor and decoded. U.S. Pat. No. 5,329,108 discloses a map with indexes and an associated document reader. The indexes are composed of a group of dots placed on the map in the vicinity of the associated elementary area. The dots form a specific code for the area and are readable by an optical reader.

Although, there are known systems which use invisible embedded invisible code, there has been no development of technology in fields outside the foregoing fields where similar technology would prove to be beneficial.

### SUMMARY OF THE INVENTION

By the present invention, the use of encoding techniques wherein there is invisible code embedded under visible indicia is expanded to applications in the financial, military, music, and security fields.

An object of the invention is to provide an information system comprising an electronically-accessible data record.

Another object of the invention is to provide an information system for use in information management for musical and theatrical entertainment comprising an electronically-accessible data record, including a performance element; a substrate having thereon one or more printed codes practically imperceptible to a human being; and a device having an optical reader capable of reading a selected one of the one or more printed codes on the substrate, non-volatile memory and a controller, the device further having means for providing humanly perceptible feedback, the non-volatile memory storing the performance element.

Another object of the invention is to provide one or more printed codes on the substrate, wherein there can be a pre-printed material visible to the naked eye which is in substantial registration with at least one or more of the printed codes.

Another object of the invention is to provide printed codes on an intermediate substrate, which has at least one of an adhesive layer and a protective layer, neither which is made of a material that obscures the ability of the optical reader to read the printed code.

Another object of the invention is to provide the intermediate substrate on a sheet with one or more immediate substrates, wherein the individual intermediate substrates can be of different shapes.

Another object of the invention is to provide the device with circuitry for updating the non-volatile memory.

Another object of the invention is to provide the device with a means for recording data into a device.

Another object of the invention is to provide a system wherein a radio transceiver sends the recorded data via the first and second radio transceivers to the data record creation, storage and update subsystem along with a device identification code and data sufficient to determines-specific code, the device identification code being stored in the non-volatile memory of the device and the data sufficient to determine specific code being read from the printed codes on the substrate

Another object of the invention is to incorporate the features of the above-mentioned system into varying applications, wherein, a substrate having thereon one or more printed codes practically imperceptible to a human being; and a device having an optical reader capable of reading a selected one of the one or more printed codes on the substrate, non-volatile memory and a controller, the device further having means for providing humanly perceptible feedback, and the non-volatile memory storage capability would be useful.

Another object of the invention is to provide a substrate which is a piece of sheet music and wherein the performance element is selected from the group comprising a rhythm, a specific voice range, a specific instrument, a choir, an individual vocalist, and individual music notes and the performance elements are further selected from the group comprising bar by bar; rift by rift, and movement by movement.

Another object of the invention is to provide a substrate which is a theatrical script and the performance element is selected from the group comprising standard instrumental, piano assist, vocals, full orchestra, and theatrical dialog, and wherein the electronically accessible data record includes a plurality of theatrical dialog performance elements wherein the device may be set to play the plurality of theatrical dialog performance elements in order.

Another object of the invention is to provide a theatrical script wherein the plurality of theatrical dialog performance elements includes first theatrical character dialog and second theatrical character dialog.

Another object of the invention is to provide a device to be used with a theatrical script wherein the device can be instructed by a printed code to stop playback immediately before playback of any dialog of the first theatrical character, the device can be instructed by a next-line printed code to resume playback at the next second theatrical character dialog, and the device can be instructed by a forgot-my-line printed code to resume playback at the next first theatrical character dialog.

Another object of the invention is to provide hand-held cards wherein the next-line printed code that instructs the device to resume playback at the next second theatrical character dialog is printed thereon, and on the opposite side of the card the forgot-my-line printed code that instructs the device to resume playback at the next first theatrical character dialog is printed.

These and other objects and advantages of the present disclosure will be apparent to those of ordinary skill in the art having the present drawings, specifications, and claims before them. It is intended that all such additional systems, methods, features, and advantages be included within this description, be within the scope of the disclosure, and be protected by the accompanying claims.

### BRIEF DESCRIPTION OF THE DRAWINGS

FIG. 1 of the drawings is an exploded view of the printed code 50 associated with various substrates 155 and a representative view of the hand-held device 300.

FIG. 2 of the drawings is an illustration of the use of adhesive stickers to carry the printed code 50 for association with the substrate, which is subsequently covered by a practically transparent substrate.

FIG. 3 of the drawings is a representation of the components comprising the hand-held device 300.

FIG. 4 of the drawings is a block diagram of the optical reader 310 shown in FIG. 3.

FIG. 5 of the drawings is an alternative embodiment of the hand-held device 300.

FIG. 6 of the drawings is an illustration of the entry of initial patient data into a patient records database 395 associated with the system.

FIG. 7 of the drawings is an illustration of printing a sheet of various sized labels and a patient identification bracelet associated with new patient admittance.

FIG. 8 of the drawings is an illustration of the patient identification bracelet 4000 that is generated for the patient upon admittance.

FIG. 9 of the drawings is an exploded view of the information portion of the patient identification bracelet 4000.

FIG. 10 of the drawings is an illustration of one manner of connecting the hand-held device 300 to the remainder of the system such that patient data may be saved in substantially real-time if the radio frequency link is active.

FIG. 11 of the drawings is an illustration of one manner of connecting the hand-held device 300 to the remainder of the system showing collection of patient data through microphone 345 and organization of same in the patient records database 395.

FIG. 12 of the drawings is an illustration of a prescription drug verification function of the system.

FIG. 13 of the drawings is an illustration of the prescription bottle substrate.

FIG. 14a of the drawings is an illustration of the identification card 5000.

FIG. 14b of the drawings is an illustration of the identification card 5000 depicting the invisible printed regions containing the printed code.

FIG. 15 of the drawings is an illustration of one potential use of the hand-held device 300 to read an identification card 5000.

FIG. 16 of the drawings is an illustration of one example of instructional material 6000 which may be used with the hand-held device 300.

FIG. 17 of the drawings is an illustration of a display label 7000 which may be used with the hand-held device 300 in a museum-type setting.

FIG. 18 of the drawings is an illustration of an example theme park map 7050 which may be used with the hand-held device 300 in a theme park setting.

FIG. 18a of the drawings is an illustration of one embodiment of a use in a theme park wherein the hand-held device 300 can be used for entertainment while waiting in line at various attractions.

FIG. 19 of the drawings is an illustration of a financial/legal use of the hand-held device 300 where the substrate 155 is a fillable sheet 8000.

FIG. 20 of the drawings is an illustration of a marketing document 9000 for use with a hand-held device 300.

FIG. 21 of the drawings is an illustration of a soldier using the system to learn the operation of a weapons system.

FIG. 22 of the drawings is an illustration of one example of a music application for use with the hand-held device 300.

FIG. 23 of the drawings is an illustration of another example of the music application.

FIG. 23a of the drawings is an illustration of a musical score cover which is used to contain a musical score for use with a hand-held device.

FIG. 24 of the drawings is an illustration of one embodiment of the ticket 10000 application using the hand-held device 300.

### DETAILED DESCRIPTION OF THE DISCLOSURE COMMON TO ALL INVENTIONS

While the present disclosure may be embodied in many different forms, the drawings and discussion are presented with the understanding that the present disclosure is an exemplification of the principles of one or more inventions and is not intended to limit any one of the inventions to the embodiments illustrated.

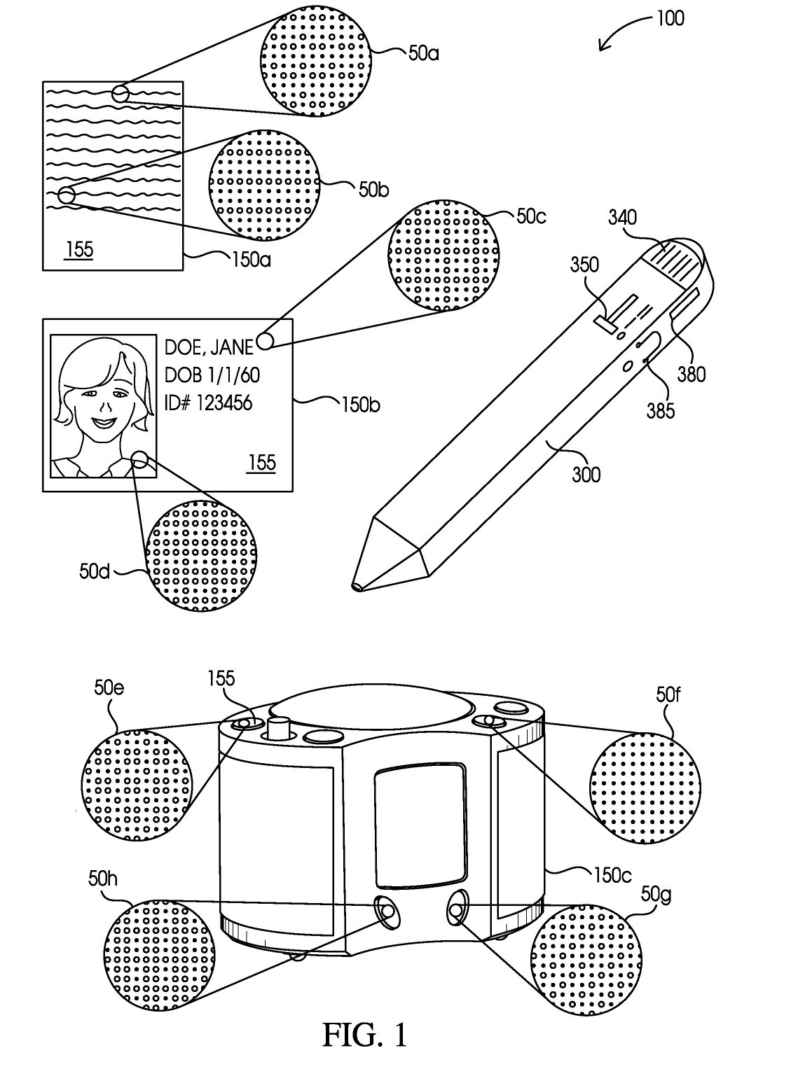

As shown in FIG. 1, a system 100 including a printed code 50 printed on a substrate 155 and a hand-held device 300 is disclosed. While the specification will primarily speak in terms of hand-held device 300, it is contemplated that the hand-held device 300 could be replaced in some system 100 by a non-portable, stationary device.

Various types of printed codes may be used in the system 100, including those types of encoding techniques taught by U.S. Pat. Nos. 3,786,237; 4,604,065; 4,627,819; 4,990,093; 5,329,108; 5,416,312; and 7,350,718. Other types of printed codes are also contemplated as being within the scope of the present disclosure. The printed codes may be printed in association with the process of mass printing visible indicia on one or more printed pages, such as is disclosed in U.S. Pat. Nos. 3,786,237; 4,604,065; 4,627,819; 4,990,093; 5,329,108; 5,416,312; and 7,350,718. The printed codes may be printed before or after the visible indicia as part of the same printing process.

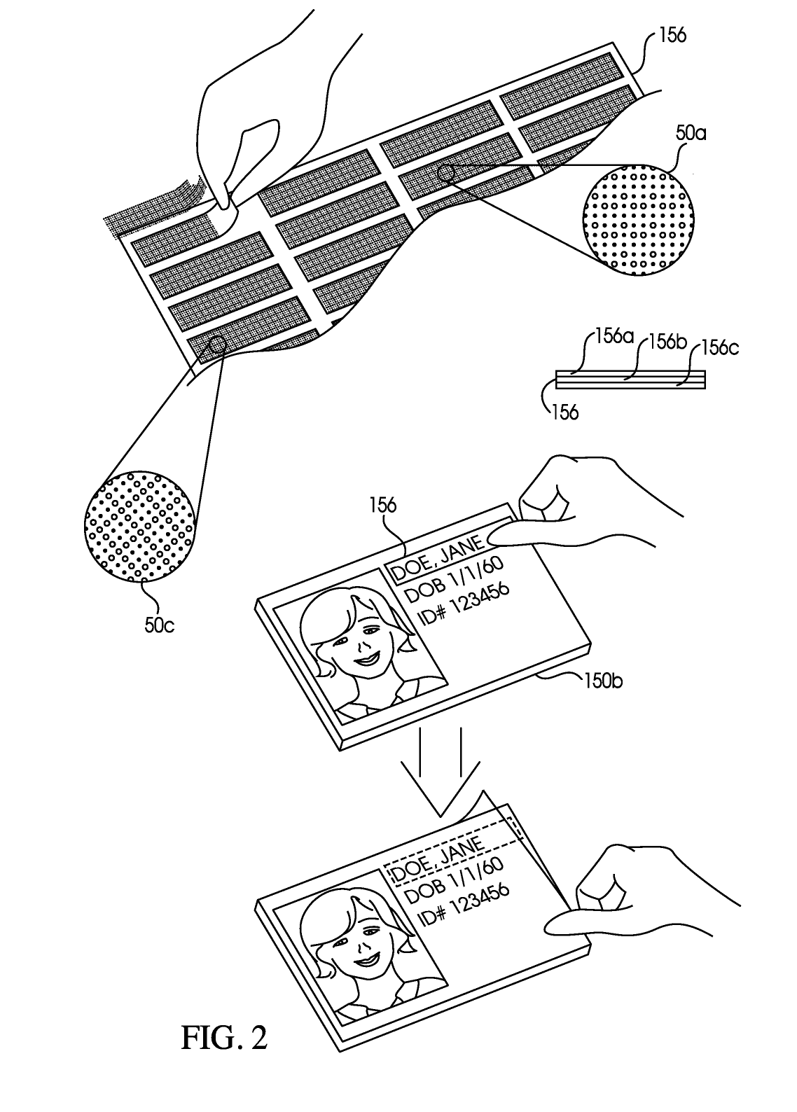

As depicted in FIG. 2, it is contemplated that the printed code 50 may be humanly perceptible before it has been physically associated with substrate 155. However, the printed code 50 is practically imperceptible to a human being once it has been associated with a substrate 155, such as printed matter 150a or even a surface of an article 150c (see FIG. 1 or FIG. 2).

The term “article” for purposes of the present disclosure is intended to exclude mass printed matter, such as books, instruction booklets, magazines, newspapers, stock prospectuses, training guides, and user manuals. While “article” would certainly include three-dimensional objects, it is not intended that the meaning of “article” be so limited. So, for instance, electronic equipment (such as a DVD player), identification cards or passports, electronics (such as an alarm clock 150c, toaster, or microwave oven), medical devices, identification cards 150b, medical identification bracelets, prescription medicine containers, and vehicles are all examples of “articles” that may be associated with this system. Articles and mass printed material may be collectively referred to as having substrates 155 upon which the printed codes 50 are placed.

Association of the printed code with substrate 155 may be achieved by directly printing on the substrate 155. The association of the printed code 50 with a previously created substrate 155 may be achieved by printing the codes directly on the previously created substrate 155 or via an intermediate substrate 156, which is then physically associated with the substrate 155. As shown in FIG. 2, the intermediate substrate 156 may be an adhesive sticker having one or more layers of adhesive 156c and a printable layer 156b. In some embodiments, the adhesive sticker may further include a protective layer 156a on top of the printable layer, where the protective layer is made such that it does not significantly obscure the ability, of the hand-held device 300 to read the printed code on the adhesive sticker. The adhesive sticker may be made of layers that, at most, do not significantly obscure the substrate 155 below. However, for some articles, the adhesive sticker may obscure what lies underneath. Adhesive stickers may be produced in pre-printed sheets or rolls for mass application during mass production of substrates.

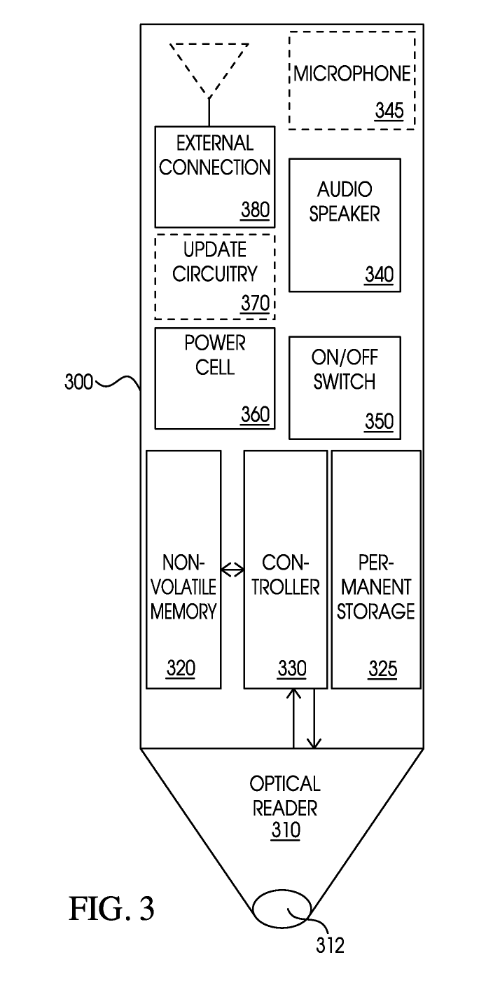

As shown in FIG. 3, the hand-held device 300 of the system 100 comprises an optical reader 310 capable of reading the selected printed code; non-volatile memory 320; a controller 330; an audio speaker 340; an on/off switch 350; and a power cell 360 (such as a battery). The interconnections between the elements are not shown because such connections are well understood and to avoid obscuring the invention. The hand-held device housing would most preferably be shaped like a pen, however; other housing shapes and sizes may also be used. It is contemplated that the system may be incorporated into any stationary or hand-held device 300 so long as that device has the appropriate optical reader capabilities. So, for instance, it is contemplated that a mobile telephone having a CMOS camera could be used as the hand-held device 300 in the present system. While the present disclosure may speak in terms of “touching” the hand-held device 300 or pen to the substrate, this term should be understood for purposes of the present disclosure to encompass not only physically touching the hand-held device's sensor window 312 to the substrate 155, but also bringing the sensor window 312 in sufficiently close proximity to the substrate 155 for the optical reader 310 to read the selected printed code 50.

The non-volatile memory 320 of the hand-held device 300 is preferably rewriteable and may be removable from the housing of the hand-held device 300. The non-volatile memory 320 may also be physically fixed within the hand-held device 300. The non-volatile memory 320 may be proprietary or may be selected from commonly available, forms of non-volatile memory 320, such as EEPROM, EPROM, Flash Memory, SDRAM, SRAM, and memory cards, including, but not limited to, CompactFlash (CF), JEIDA, Memory Stick (MS/MS-PRO), miCard, Microdrive (MD), MultiMediaCard (MMC), Secure Digital (SD), microSD, SmartMedia (SM), and xD-Picture. The non-volatile memory 320 is used, among other things, to store the printed codes, audio, and programming used by the controller 330 to operate the desired functions of the hand-held device 300, as will be discussed more fully below. The audio may be encoded or raw and may comprise music, sound effects, and/or even speech synthesis data.

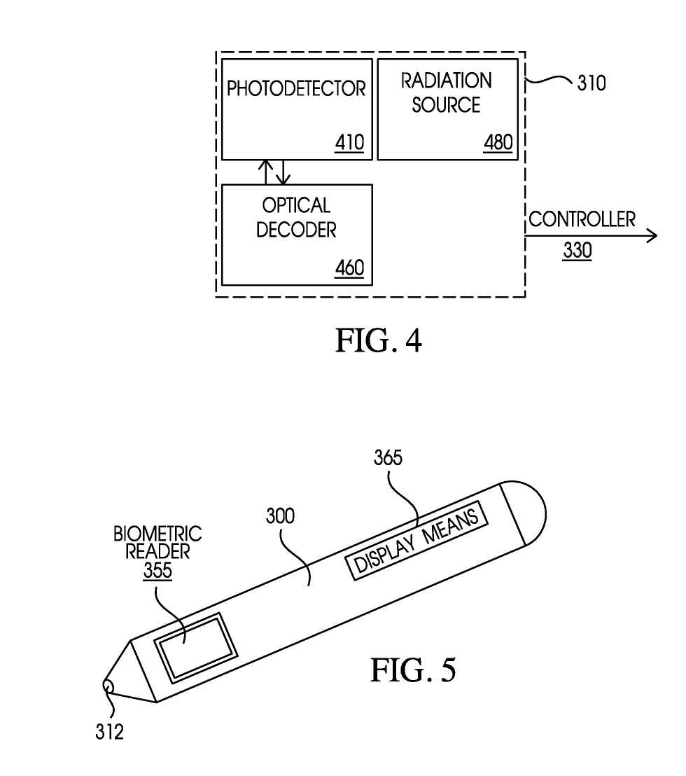

Preferably, the non-volatile memory 320 of the hand-held device 300 is rewriteable, although it is possible that a portion of the non-volatile memory 320 will be write once storage (WORM) or even read only memory (ROM) which shall be referred to as permanent storage 325 (FIG. 3). It is contemplated that the hand-held device 300 may be assigned a unique-identification number, which would be stored in either WORM or ROM either at the factory or by a company deploying the hand-held devices 300. Where the hand-held device 300 includes rewriteable memory, the device may further include circuitry capable of rewriting the rewriteable, non-volatile memory 320. The update circuitry 370, as shown in FIG. 4, may interface with external devices, such as a specialized computer, a general-purpose computer, or a remote server, via a wired or a wireless connection.

Where the external connection 380 is wireless, the hand-held device 300 would further include a radio transceiver. The wireless connection could be 2G, 3G, Bluetooth, CDMA, DECT, TDMA, UMTS-TDD, WiBro, WiFi, or WiMAX to name a few. Wired connections may be proprietary or constructed in accordance with a standard such as USB or FireWire (IEEE-1394).

The controller 330 of the hand-held device 300 may be comprised of any group of electrical components, firmware and software sufficient to operate the functions of the hand-held device 300. Among the potential groups of electrical components for implementing the controller 330 are general-purpose microprocessors, special purpose microprocessors, and ASICs. The controller 330 will have likely have volatile memory elements (e.g. registers) and access to the non-volatile memory 320. In some instances, the controller 330, itself, will preferably have separate non-volatile memory 320, which comprises a part of the overall non-volatile memory 320 of the hand-held device 300. The controller 330 provides a means for controlling the functions of the hand-held device 300 and coordinating those functions to produce the functionality disclosed herein. The controller 330 may also keep real time or at least system time.

The audio speaker 340 of the hand-held device 300 is primarily used to provide audible instructions, information and other feedback to the user of the hand-held device 300. The controller 330 is operably connected to the audio speaker 340, such that pre-recorded audio, synthesized audio, or text-to-speech output may be audibly played through the audio speaker 340. It is contemplated that the hand-held device 300 could also include an audio jack such that an external headphone or independently-amplified external speaker could be used instead of or in addition to the audio speaker 340 in the hand-held device 300.

The on/off switch 350 of the hand-held device 300 is preferably a slider switch, but could be a momentary contact switch or any other type of electro-mechanical switch. In a preferred embodiment, the on/off switch 350 may be a three position slider switch. Those three positions are preferably: off, on at a low volume, and on at a higher volume. It would be understood by those skilled in the art having the present disclosure before them that the on/off switch 350 could be a two-position switch with preset volume or volume selectivity could be provided by a potentiometer with an adjustment wheel or knob accessible on the face of the housing.

The power cell 360 of the hand-held device 300 is preferably a battery. The battery may be a disposable or a rechargeable battery. In the case of a rechargeable battery, the hand-held device 300 would include charging circuitry and would preferably include software to optimize the recharging of the battery. As is known, where the hand-held device 300 includes a USB port (see 380, FIG. 1), external power may be provided to the device via the USB port to recharge the battery. In an embodiment with no physical ports, inductive charging may be used as is well known in the art. The hand-held device 300 would also preferably include a low-battery warning mechanism.

The hand-held device 300 may also optionally include a microphone 345. In such an embodiment, the controller 330 would also have the ability to record the audio input via the microphone 345. This recorded audio may be saved in its analog form or may preferably be digitized. In some embodiments, the controller 330 may include a speech-recognition engine that translates the audio into text. The audio or digital representation thereof (either pure digital or text-translation) may be stored by the controller 330 in the hand-held device 300 or that audio may be transmitted either wirelessly or by wire to or from a computer or remote server.

FIG. 4 shows the optical reader 310 includes a photodetector 410 and an optical decoder 460. The photodetector may comprise a single row, but preferably includes a two-dimensional array of semiconductor devices (such as a charge-coupled device (CCD) or CMOS optical sensors), each associated with an amplifier and an optical filter. The optical filter generally allows a band centered wavelength of light to pass. The center of the band of frequency or frequencies selected depends upon the printed code system chosen. The size of the semiconductor row or array may also be adjusted depending upon the printed code system selected. For instance, in an embodiment deployed with a mobile telephone CMOS camera at least three wavelengths will be filtered and, hence, sensed (blue, green, and red), so the printed code system may be selected to take advantage of the ability of an array to sense one, two or all three wavelength bands of light. In an embodiment where the printed bode system relies on infrared wavelengths, the optical reader 310 may also include a source of infrared radiation 480, such as a LED and the filter pass-band would be selected accordingly. The image sensed by the photodetector 410 is read out into the optical decoder 460, which may be part of the controller 330 or a discrete set of circuitry. The optical decoder 460 gathers the sensed optical signals and translates those signals into images that are matched against the known aspects of the selected printed code. Once the optical signal is decoded, the information is passed out of the optical reader 310 to the controller 330.

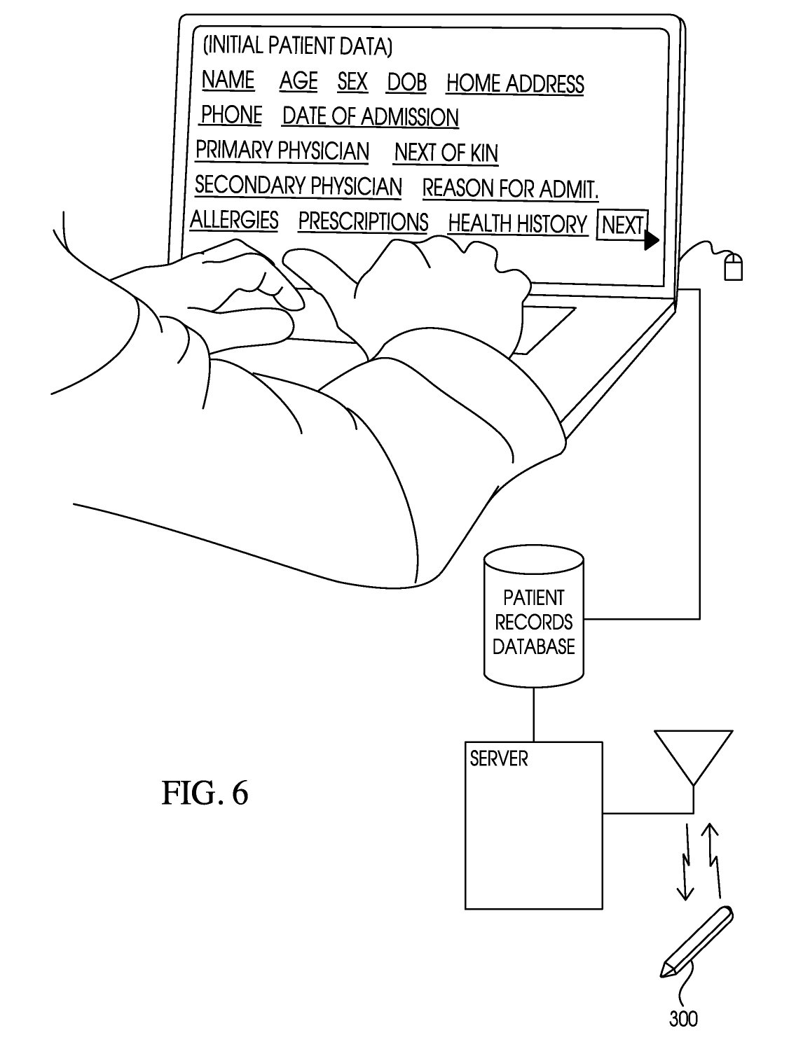

As shown in FIG. 5, the hand-held device 300 may also optionally include a visual display means 365 on the housing. The visual display means 365 may be as simple as a single, colored light emitting diode or it may be as complex as a liquid crystal display (LCD) or LED display, such as those found in hand-held calculators. The controller 330 would drive the visual display means 365 as is known by those in the art.

As also shown in FIG. 5, the hand-held device 300 may optionally include one or more biometric sensors 355, such as a fingerprint reader, or biometric analysis such as a voice-analyzer or handwriting analyzer. One or more of these biometric sensors 355 may be used alone or in combination with each other and/or a password to provide some level of security for the system. The controller 330 would support the biometric sensing capabilities using peripherals. For instance, where voice analysis is used the microphone 345 would be used in combination with the controller 330 and memory to judge whether the user is matched with hand-held device 300. In another example where handwriting analysis is used, the hand-held device 300 would further include an ink cartridge and could further include an accelerometer and/or a pressure sensor to judge the speed, angle and pressure of the user's writing style. The hand-held device 300 may also have the ability to perform optical character recognition.

In an embodiment including biometric or other security, once the user identity is sufficiently confirmed, the hand-held device 300 may communicate with the outside world using unique identification number assigned to that the hand-held device 300. In secure transaction environments, the communications will be encrypted and otherwise secured by the controller 330. That communication may be further secured after the first communication hop taken by communication outside of the hand-held device 300, e.g. the personal computer to which the hand-device is operably coupled.

In an embodiment of the hand-held device 300 having the audio speaker 340, the multi-lingual and visually-impaired communications may impact each and every application. It should be relatively straightforward—based on the foregoing disclosure—to begin to understand how this system can help visually-impaired individuals by reading out loud printed matter from encoded substrates. The multi-lingual aspect requires some additional discussion. The substrate 155 may be printed in a manner that is appropriate for the majority of readers in a particular environment (e.g. English language in 12 pt font), yet the hand-held device 300 may be programmed to selectively read the substrate 155 in English or a different language, such as Chinese, French, Japanese, Polish, Russian, or Spanish, to name only a few potential languages. To facilitate the language change an icon printed on the substrate 155 to lie read or on a separate command substrate 155 would visually convey to the user that touching the hand-held to the icon would change the language spoken by the hand-held device 300. The hand-held device 300 preferably responds by audibly indicating the language mode the device is in (e.g. “Españole” for Spanish).

The hand-held device 300 may be used in a variety of applications, including in the healthcare field, authentication and security applications, education/instructional applications, museum or theme park applications, financial/legal applications, marketing applications, military/training applications, music and entertainment applications, and ticket applications.

### Healthcare Applications

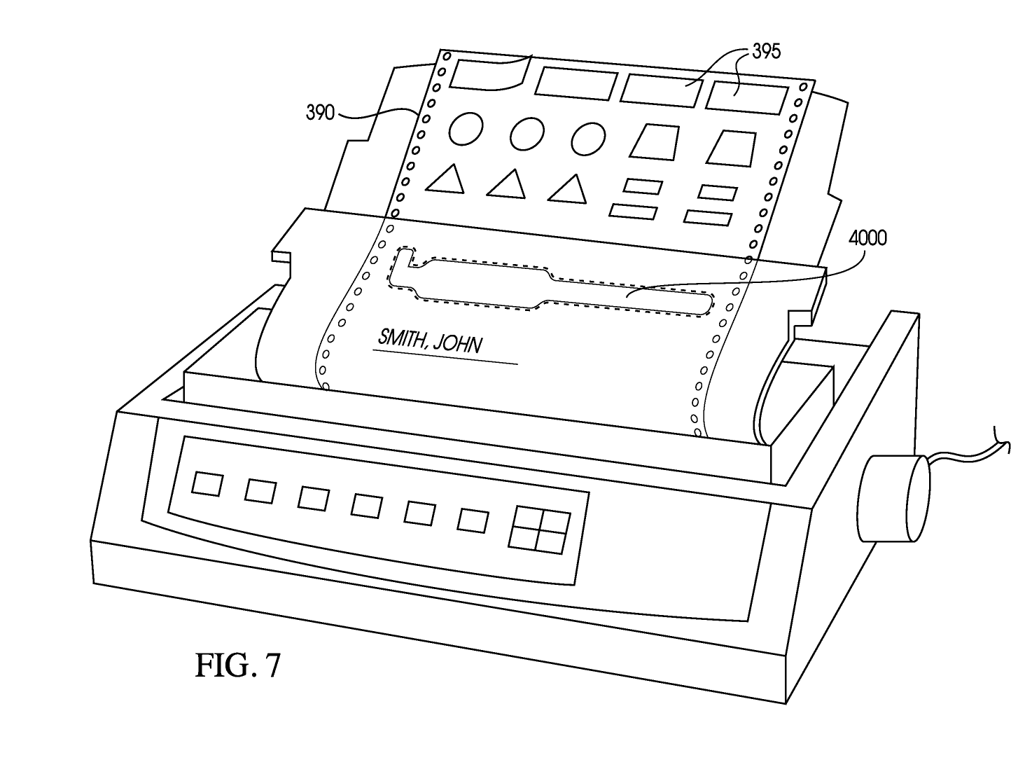

As shown in FIG. 6, as part of the admissions process for the patient, a data record would be created by entering information into a hospital admissions database 395 including, for example, the patient's name (e.g. Smith, John M) and the other information that is commonly visibly depicted on a patient identification bracelet. As shown in FIG. 6, this data record may include additional information beyond that printed on a typical patient id bracelet as well as additional fields for drug allergies, patient event summaries; examination notes; one or more sets of vital signs; and nursing instructions. The fields depicted in this data record are merely intended to be illustrative of the possible data contained in the initial patient data record. This initial patient data record would be stored in the healthcare facilities computer database 395. The information is then accessible to the hospital server 375, and then, for example, the specific patient information can be wirelessly upload into a hand-held device 300 for a specific patient. Moreover, additional information can be added to the patient record via the hand-held device 300.

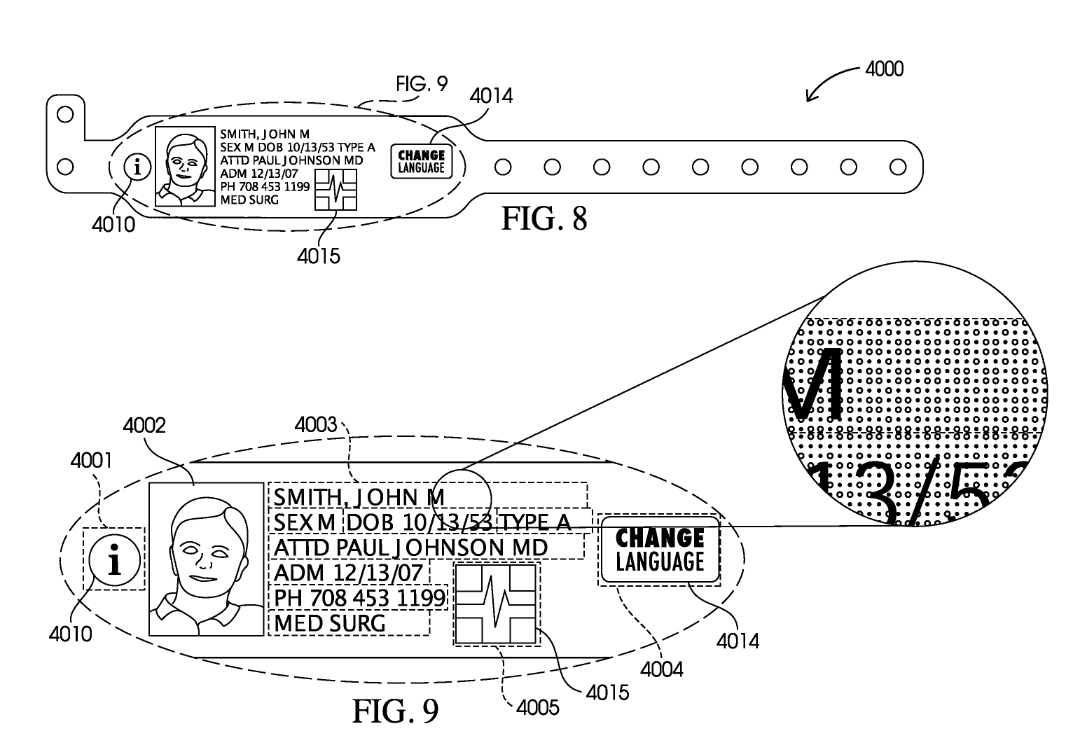

As shown in FIG. 7, after entering the initial patient data record, the record is used to print a new patient admittance sheet 390 comprising pre-printed labels 395 and the patient's identification bracelet 4000. As shown in FIG. 7, the pre-printed labels 395 may be a variety of different shapes to facilitate the use of the labels in a variety of healthcare specific objects such as on blood and urine samples, medication, and medical supplies. The labels may also have a specific color, shape, number, letter, or other modification to more readily identify a particular hospital procedure or test. As further shown in FIG. 7, the completed patient id bracelet 4000 may be printed with the new patient admittance sheet 390 and easily removed via the perforations in the sheet.

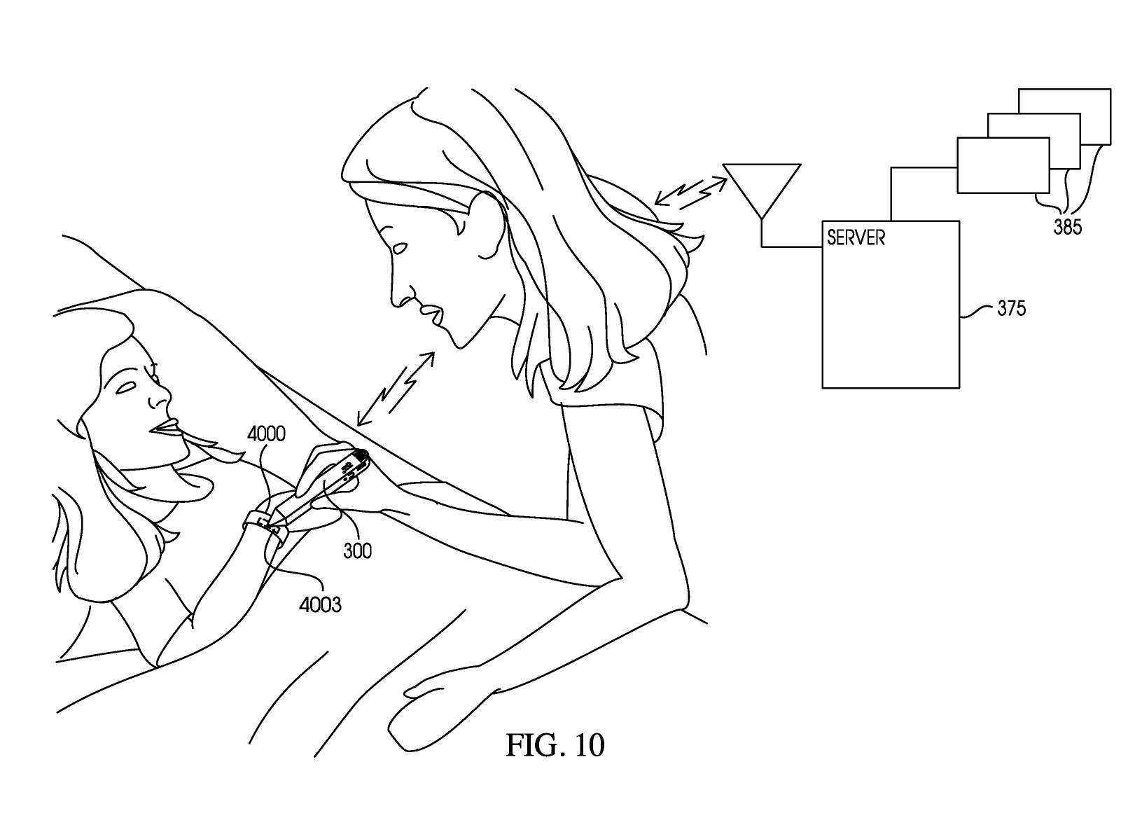

As shown in FIG. 8, the substrate 155 may comprise a patient identification bracelet 4000. As was previously known, patient identification bracelet 4000 is fixed around a patient's wrist or ankle to ensure identification of the patient throughout their stay at the healthcare facility. The patient identification bracelet 4000 is usually printed on a flexible durable substrate such that the printing disposed thereon would be expected to survive the conditions reasonably expected for a patient's stay in the healthcare facility. Although the patient identification bracelet is shown as including a digital photo of the patient, inclusion of such photo is optional. Similarly, other information not shown on the patient identification bracelet 4000 depicted in FIG. 8 may be printed on the bracelet by the healthcare facility.

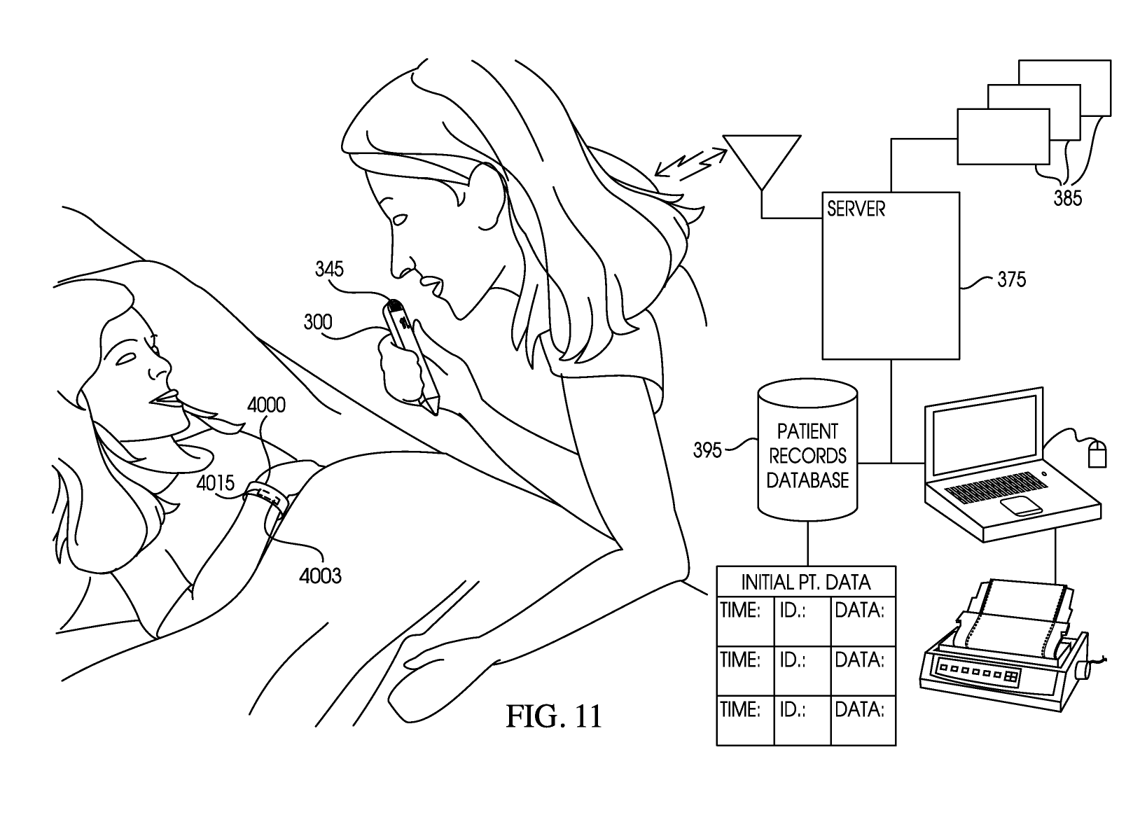

For purposes of the present invention one or more printed codes (not visible to the human eye in FIG. 8 in accordance with the present invention) are associated with one or more printed regions on the patient identification bracelet. FIG. 9 illustrates some of the printed regions 4001, 4002, 4003, 4004, and 4005 on patient identification bracelet 4000. The patient identification bracelet 4000 illustrated would actually have at least seven more printed regions, which regions are indicated on FIG. 9 but not given reference numbers to avoid obscuring the figure. As shown in FIG. 8 these “regions” are not actually visible to the naked eye in operation.

Within each printed region 4001, 4002, 4003, 4004, and 4005 a single printed code would be repeatedly printed so as to cover the entirety of the select region. These printed codes would be sufficiently unique to the patient such that the codes of a first patient would not be mistaken for the codes of a second patient within the same healthcare facility during the same period of time. The codes may be recycled by the healthcare facility, but preferably not for lengthy periods of time. These printed codes may be printed on the substrate 155 at the same time that visible information is printed on the patient identification bracelet 4000 (see FIG. 7) or the regions may be pre-printed on the substrate 155. Where the printed codes are pre-printed on the patient identification bracelet, the healthcare facility would be provided with means for associating the group of preprinted printed codes from the specific patient identification bracelet used for the particular patient. This means may include a hand-held device 300 and the printing of the codes on a designated section of new patient admittance sheet 390.

It should also be understood that some of the visible printing on patient identification bracelet 4000 may also be pre-printed such as information symbol 4010, change language icon 4014, and healthcare facility logo 4015, as illustrated in FIGS. 8 and 9.

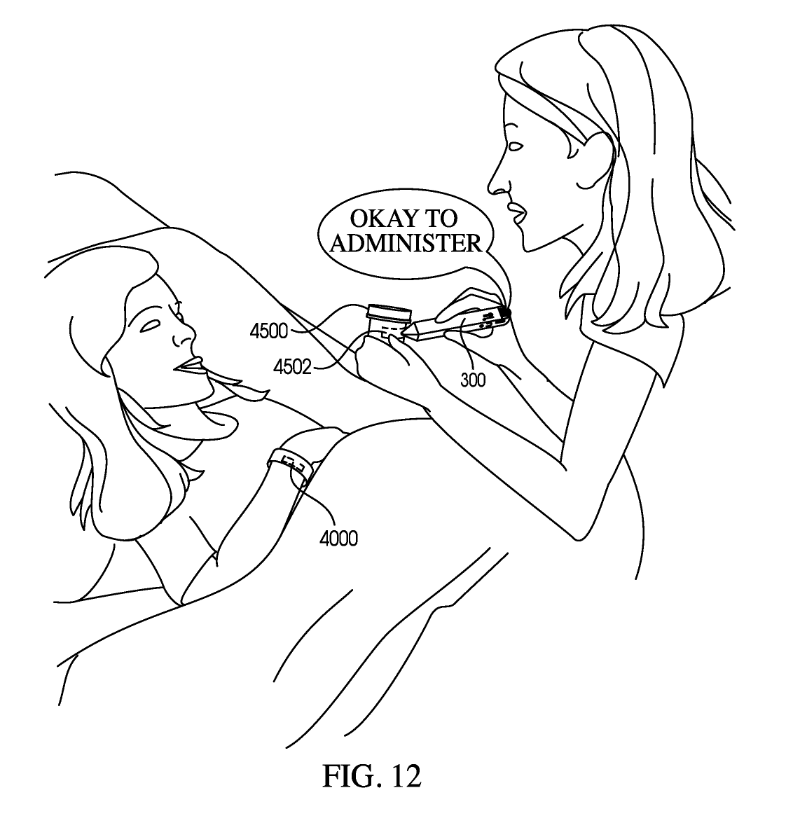

As shown in FIG. 10, a healthcare worker, such as a nurse, caring for the patient may have a hand-held device 300. The non-volatile memory 320 in the device may have been loaded with the patient data records for all of the patients in the healthcare facility or, as may be more likely the case due to memory size constraints, it may have been loaded with relevant portions of the patient data records for patients in the healthcare worker's assigned location within the healthcare facility (e.g. the Surgical Ward). The downloading of the patent data records may be accomplished wirelessly or by wired connection. The healthcare worker touches the hand-held device 300 to a region of the patient identification bracelet, such as region 4003 containing the patient's name. The hand-held device 300 registers the patient name and the device preferably audibly states the patient's name.

The healthcare worker may next touch the hand-held device 300 to the region 4001 including information symbol 4010. In an illustrated embodiment, touching the printed codes associated with information symbol 4010 will cause the hand-held device 300 to audibly read-out any patient event summaries logged in the patient records database 395 within the last few hours (perhaps even eight or more hours) subject to the last update of the non-volatile memory 320 in device 300, which depends on whether the system is updated wirelessly or by wired connection. In a wirelessly updated system, the memory 320 onboard the hand-held device 300 may be updated in substantially real time. As is depicted in FIG. 10 via the bi-directional RF arrows, data may be transmitted from a server 375 via an RF antenna to the device 300.

It should be understood that the printed code associated with the information symbol 4010 could be associated with any information included the patient data record, such that the information is read aloud by the hand-held device 300 upon touching the information symbol 4010. In another example, touching the region associated with the visible printing “MED SURG” on the patient identification bracelet would prompt an audible message that may include more information about the surgery, for instance, “patient is admitted for scheduled surgery on his right carotid artery, on Jun. 4, 2008.”

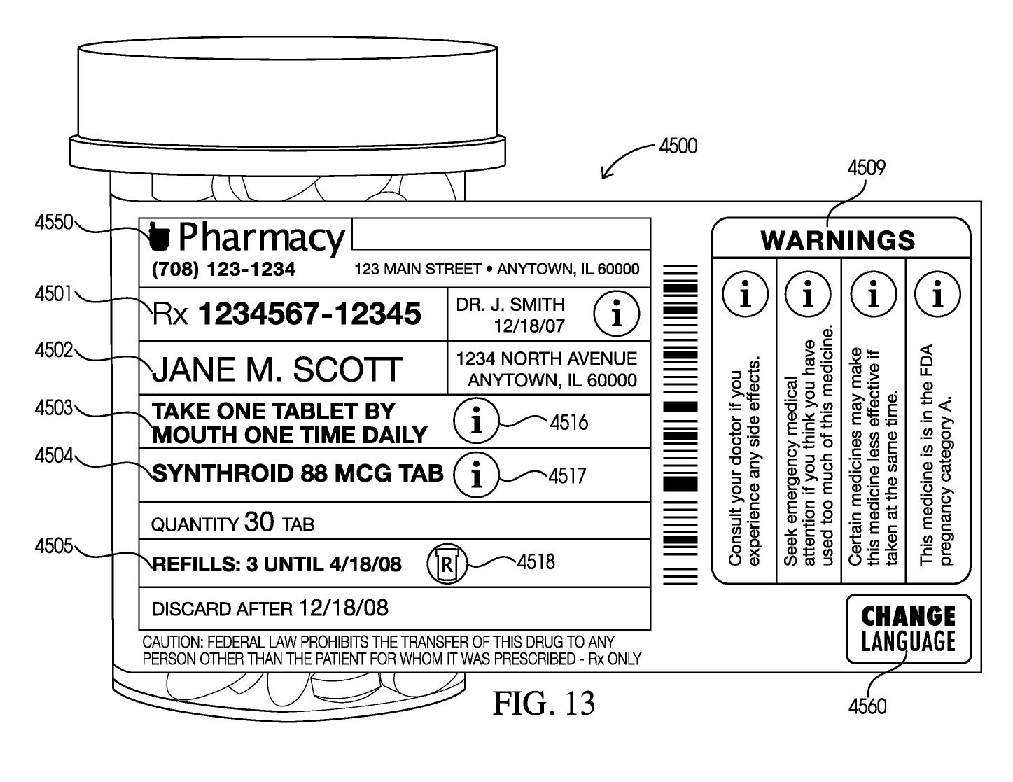

As shown in the illustrated embodiment of FIG. 11, the healthcare worker may record vital signs or other activities conducted in association with the patient directly into the hand-held device 300 using the optional microphone 345. So, for instance, by touching the device to the healthcare facility logo 4015, the hand-held device 300 would record the unique patient identification and may indicate (preferably audibly) that it is ready to receive data and switch into audio record mode. At that time, the healthcare worker would audibly state something like, “BP 120 over 80, pulse 88, temp 99.2, pupils normal, color good” and then touch the healthcare facility logo 4015 again to stop the recording. In addition to the audio record, the recorded record would also include the patient identification (as indicated by the unique printed code associated with the healthcare facility logo 4015), the unique identification number embedded in permanent storage 325 of the hand-held device 300 and would preferably also note the real-time the record was recorded. In addition to being stored on the hand-held device 300, that patent event record may be uploaded to the healthcare facility's computer system. As shown in FIG. 11, this upload may be via a wireless RF link to the server 375 and in turn the patient records database 395. The data saved each patient's record in the database 395 would include the initial patient data from admitting as well as other data such as lab tests, physical examination records, vital sign updates, scheduled testing procedures, nurse's notes, and more. This data can be inserted from various workstations 385 throughout the healthcare facility or even from a computer in the patient's room. Other than the initial patient data, data is preferably organized by time in reverse chronological order such that the most recent pertinent information is available first.

The healthcare facility's computer system may save the audio record in the patient data record and may also convert the audio record to text. In a preferred embodiment, the text copy of the record (which would include not only the record spoken by the healthcare worker, but also their name and the record time), is used as the source of information read out to healthcare workers that subsequently touch Mr. Smith's information symbol 4010. Using this approach would likely expedite and simplify conversion of the information to another language if such language is needed for the user of another hand-held device 300.

It should be understood that the healthcare worker could be a phlebotomist taking blood samples and recording into the patient data record using a hand-held device 300 something to the effect of “two vials of blood were drawn,” which would then be associated with the real time, the hand-held device identification number and the patient for recording in the patient data record. Similar examples can be given of physical, occupational, respiratory and other therapists. In addition, a speech-language pathologist could even use the record function of the hand-held device 300 to record patient speech for diagnostics and later comparison purposes. The system may be taught to recognize the identification of the hand-held device 300 of each healthcare worker such that the system will cause the appropriate types of records to be generated. Alternatively, the healthcare workers may carry around a printed template that has printed codes 50 embedded thereon to instruct the device to create a variety of records or perform certain tasks.

In another example, the healthcare worker may need to contact the patient's primary doctor as listed on the patient identification bracelet 4000. In one embodiment, touching the region with the doctor's name will cause the hand-held device 300 to audibly read out the doctor's name and contact information. That doctor contact information may be static or it may, preferably be updated in real time in a separate record in the healthcare facilities database 395. So, for instance, the default message associated with the printed code printed in that region of the patient identification bracelet illustrated in the figures could be an audible message “Attending physician Paul Johnson MD. Telephone number 555-1212. Pager number 555-1213.” But, when Dr. Johnson wants the night off, he could submit to the healthcare facility computer a message that “Dr. Jane Doe is handling my patients tonight her number is 555-2121.” The computer recognizing “tonight” during speech-to-text translation, could insert the real date. This message would then be associated with Dr. Johnson's record, such that a healthcare worker now touching the doctor region of Mr. Smith's patient identification bracelet 4000 would hear “Attending physician Paul Johnson MD. Dr. Jane Doe is handling patients tonight, Sunday June 1, her number is 555-2121.” It should also be understood that Dr. Johnson's actual recording could be played instead of the textualized version created by the computer.

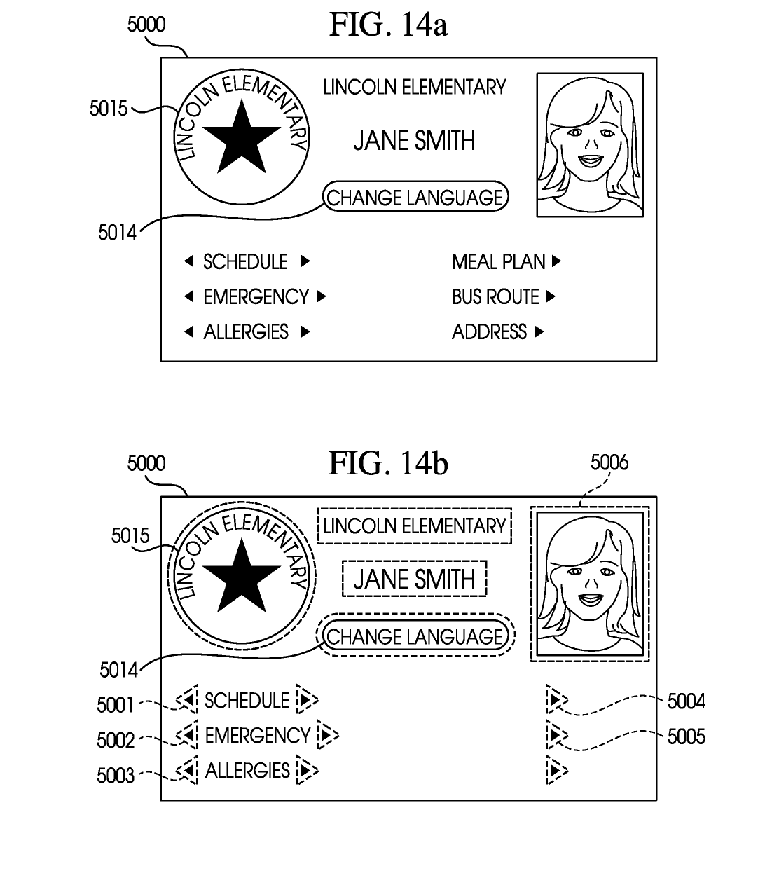

In another example, the healthcare worker may be at the patient's bedside to administer prescribed medication to the patient. After touching the patient identification bracelet 4000, as shown in FIG. 12 the healthcare worker would touch a container baring a label with printed codes. The printed codes on the prescription label may match one of the printed codes on the patient identification bracelet 4000, such as the code associated with the patient name, although the particular code selected is not particularly significant. If the printed code on the label matches the printed code on the patient identification bracelet, then the hand-held device 300 would provide an audible signal that the prescription should be dispensed. In some instances, the patient may need an emergency medication that had not been previously prescribed. In those cases, as well as the prescription example above, the healthcare worker may touch an indicated region on the general medicine packaging that has an associate printed code. If the new medication is in the list of the patient's drug allergies or an interaction warning exists between the new medication and one or more of the medications in the patient data record, an alarm would sound. That alarm may include specific information, such as “patient is allergic to sulfides” or “there is a potentially adverse drug interaction between [drug 1] and [the new medication]”.

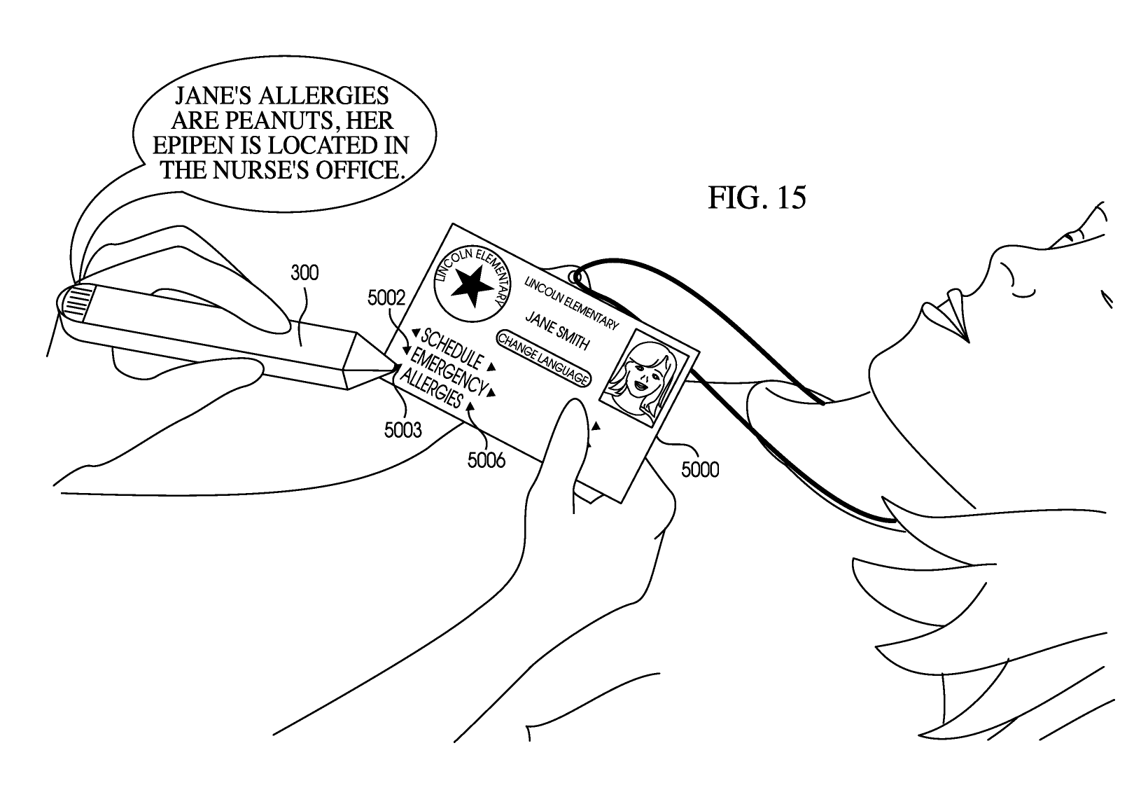

FIG. 13 illustrates a prescription filled at a retail or, mail-order pharmacy enabled for use with the present system. In this example the substrate 155 is the prescription label 4500, which has one or more printed codes not visible to the human eye associated with a respective one or more printed regions on the prescription label 4500. In this particular embodiment of the prescription label 4500, the printed regions 4501, 4502, 4503, 4504, 4505, 4506, 4507, 4508, and 4509, among others not numbered, are actually bounded by visibly printed lines and/or color distinctions. Within each printed region a single printed code would be repeatedly printed so as to cover the entirety of the select region.

The printed codes used on the prescription label 4500 may be unique or may be set. For instance, the printed code used by the prescription number 4511 and patient name 4512 should be unique within the same pharmacy or group of pharmacies (where they share a coding system). The printed codes for the pharmacy name 4550 and the drug type and dosage 4514, for instance, would not be unique to the prescription label 4500, but would be unique as among other pharmacies, other drugs and other dosages.

These printed codes may be printed on the substrate 155 at the same time that visible information is printed on the prescription label 4500. Some of the printed codes may be pre-printed on the substrate 155, particularly in this example where the information is not variable such as pharmacy name 4550. It should also be understood that some of the visible printing may also be pre-printed such as the lines that divide some of the coded regions, the information symbols 4516 and 4517, the refill symbol 4518, and the change language icon 4560.

The interaction between the prescription label 4500 and the hand-held device 300 follows as would be expected having read the present disclosure. For instance, touching the hand-held device 300 to printed region 4501 would result in the prescription number being read aloud by the hand-held device 300 through its audio speaker 340. Similarly, the hand-held device 300 would read aloud the patient name if printed region 4502 is touched; the instructions if printed region 4503 is touched, the medication type and unit dosage if region 4504 is touched, etc. This feature is particularly useful in multi-resident households where one or more residents may be visually-impaired. It is similarly useful where the user may not speak English, in which case, by touching the change language icon 4560 the hand-held device 300 reads aloud in another language even if the printed matter is in English.

The usage information symbol 4516 provides detailed information regarding the usage of the medication, for instance: “take in the morning,” “take on an empty stomach 30 minutes before eating,” “take with at least 8 oz of water,” “if you miss a dose, take as soon as possible, unless it is almost time for your next dose in which case skip the dose, do not take extra medicine to make up the dose,” “store at room temperature.” This information will vary depending upon the medication. The medicine information symbol 4517 may state the branded name as well as the generic name and could further provide warnings about potential problems in switching from branded to generic drugs. The refill symbol 4518 will order a refill from the pharmacy that originally filled the prescription, if there are refills available. In particular, the user touches the refill symbol 4518 and the hand-held device 300 states aloud, “to confirm that you want to refill your prescription please touch this button again.” After touching the refill symbol 4518 a second time, a refill order record is created in the hand-held device 300 including at least the prescription number of prescription label 4500. If the hand-held device 300 has a operative connection to the pharmacy (either directly via wireless connection or via the Internet), the order will be placed.

The prescription label 4500 may also have a printed region coded that could be touched immediately before the next dose of the medication is taken. By touching this symbol with the hand-held device 300 a record is saved that the medication was taken at the time recorded by the hand-held device 300. In any subsequent attempt to take the medication, the symbol would be touched again and the current time will be compared to the previous time record. If the time between doses is too close a user-perceivable warning will be issued by the hand-held device 300, such as an audible warning “do not take this medication yet, it is too soon since your last dose.” The user may override the message, take the medication and record the new time by touching the dosing symbol for a second time.

The prescription label 4500 may also help in the pharmacy to better ensure the correct drug is being dispensed. For instance, the printed code could be printed either on a unit or bulk container of the medication or even directly on the surface of certain medications. In either case, during the process of filling the prescription the pharmacy worker could touch the hand-held device 300 to the mediation indicated on the prescription label 4500 at region 4504 and then touch the coded region on the bulk container or on the medication itself. A pleasant tone or warning sound may be used to indicate whether there is a match.

### Authentication and Security Applications

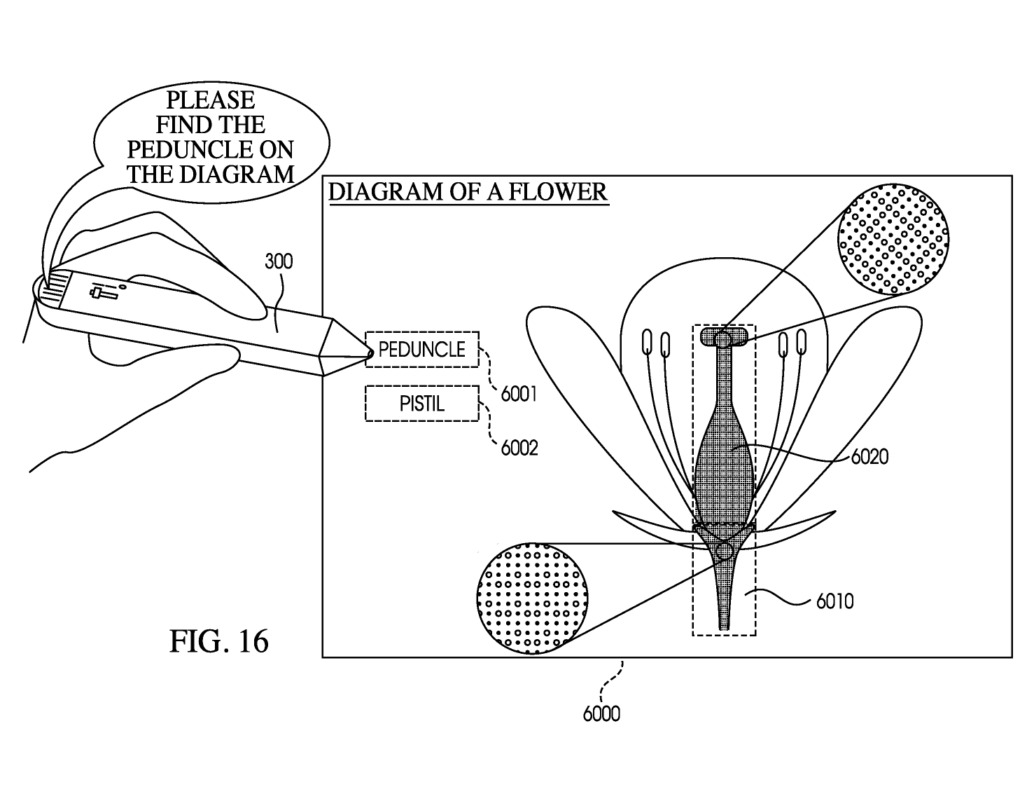

As shown in the illustrated embodiment of FIG. 14a, the substrate 155 may comprise an identification card 5000. The security features built into the hand-held device 300 provide a level of security for the identification card holder and the identification card issuer.

The identification card 5000 may be made of typical identification card-type material, and the printing disposed thereon would be expected to survive the conditions to which a normal identification card would be exposed. This would include, for example, laundering and wear associated with inserting the card in and out of a wallet. The identification card could be associated with a school, as shown in FIG. 14a, or it may be used by any other business, organization, or legal entity that might have a need for identification cards. Information printed on an identification card may include the holder's name and photograph. As depicted in FIG. 14a, the identification card may also include printed guides that provide access to the holder's schedule, emergency contact information, allergies, account balances, etc. Other information may be printed on the identification card in accordance with the needs of the identification card holder and the identification card issuer.

For purposes of the present invention one or more printed codes (not visible to the human eye in FIG. 14a in accordance with the present invention) are associated with one or more printed regions on the identification card 5000.

As described in the hospital identification bracelet application above, the visible print of the identification card 5000 could be in the same location as the words which are printed on the identification card 5000. Alternatively, FIGS. 14a and 14b illustrate another embodiment of the present invention. In the illustrated identification card, “buttons” are visibly printed on the surface of the identification card 5000 which indicate the location of the printed code regions. For example, in FIG. 14b there are printed regions 5001, 5002, 5003, 5004, and 5005 in the same location as the printed display arrows on the identification card 5000. Additionally, there is a printed region in the same location as the photograph 5006, which could include printed codes for the cardholder's name. It should be understood that the identification card 5000 could contain other types of visibly printed shapes depending on the usage of the identification cards. Additionally, the identification cards could include additional printed regions as is indicated in FIG. 14a or 14b, but not given reference numbers to avoid obscuring the figure. As shown in FIG. 14a these “regions” are not actually visible to the naked eye in operation.

Within each printed region 5001, 5002, 5003, 5004, 5005, and 5006 a single printed code would be repeatedly printed so as to cover the entirety of the select region. These printed codes would be sufficiently unique to the identification card holder such that the codes of an identification holder would not be mistaken for the codes of another identification holder. These printed codes may be printed on the substrate 155 at the same time that visible information is printed on the identification card 5000 (see FIG. 14a) or the regions may be pre-printed on the substrate 155. Where the printed codes are pre-printed on the identification, the identification card issuer would be provided with means for associating the group of preprinted printed codes from the specific identification card used for the particular card holder. Because the printed codes are practically invisible, they are difficult to copy and/or counterfeit. Therefore, the risk of counterfeiting this type of identification would be minimized in this system because the counterfeiter would be required to copy the visible printing and the printed code which is not visible. The users of hand-held device 300 may also be given different levels of authority to access information associated with the identification card. This optional functionality may also be associated with the security features of device 300 discussed above. Thus, the present invention is suitable for authentication and security applications.

It should also be understood that some of the visible printing on the identification card 5000 may also be pre-printed such as change language icon 5014, and school logo 5015, as illustrated in FIG. 14a and FIG. 14b.

It is also contemplated that the identification card 5000 may be in the form of a passport. The hand-held device 300 would be swiped across the passport at Customs which would easily identify any pertinent information regarding a specific individual. The hand-held device 300 would read the printed code on the passport to determine the identification, nationality, traveling locations, and other pertinent information about an individual. For example, if the traveler has dual citizenship, there would be printed code for such information on the passport. Furthermore, the hand-held device could wirelessly transmit information to a traveler database which could match the traveler's name and passport information against any people which may be of interest, for example, for public security, the database may easily identify potential terrorists or fugitives. Furthermore; a database could be maintained to electronically save information regarding the travel habits of individuals. Therefore, each time a passport is swiped by a hand-held device at Customs, the passport information would be wirelessly uploaded into a database and stored.

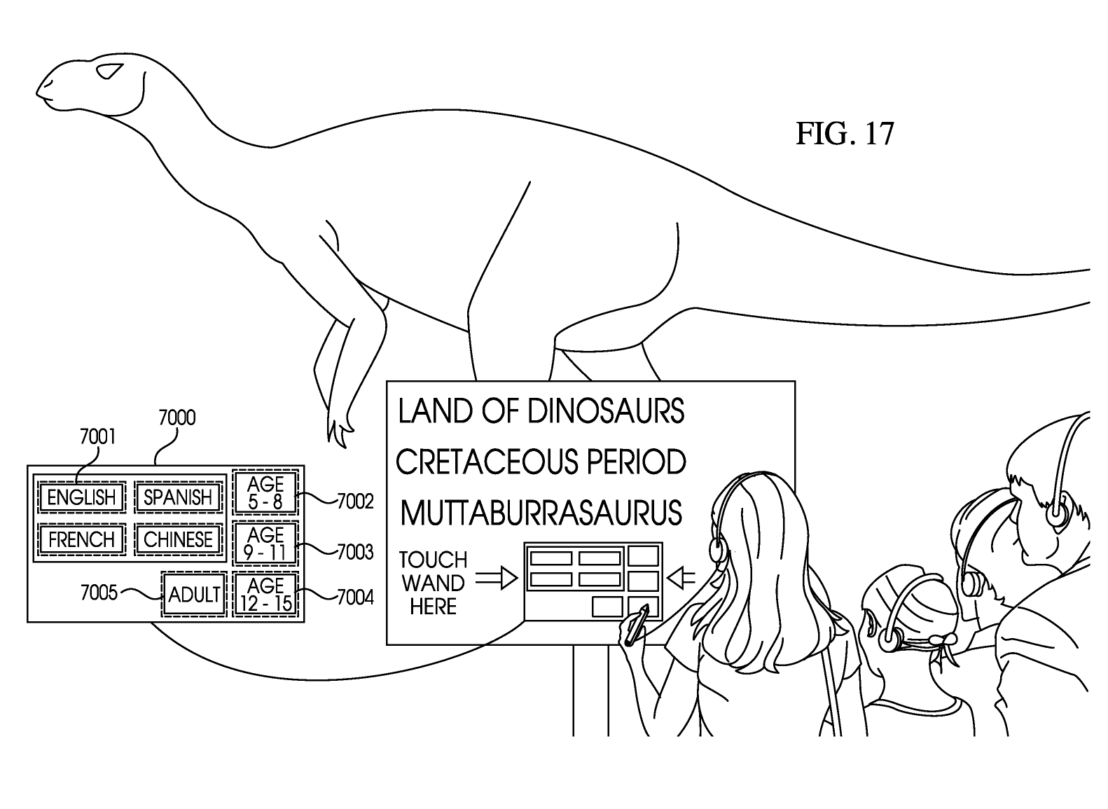

As shown in FIG. 15, the identification card 5000 could be useful in emergency situations in which the identification card holder is unable to provide information. A member of the school, such as a teacher, may have a hand-held device 300. The non-volatile memory 320 in the device may have been loaded with the student information for all of the students in the school or, as may be more likely the case due to memory size constraints, it may have been loaded with information specific to the students in the teacher's class or the teacher's assigned area within the school. The downloading of the student information may be accomplished wirelessly or by wired connection. The teacher touches the hand-held device 300 to a region of the student identification card 5000, such as region 5003 containing the student's allergies. The hand-held device 300 registers the allergies of the student and the device preferably audibly states the student's allergies and instructions on how to provide the student assistance. As is shown, but not labeled in FIG. 15, the teacher could also touch the hand-held device 300 to the arrow 5006 on the other side of the allergy label and the device would audibly provide the child's doctor's phone number and address.

The teacher may next touch the hand-held device 300 to the printed region 5002, which relates to emergency information. The teacher would be able to obtain the child's emergency contact information without having to research the child in a school records directory. For example, the arrow on the left of the emergency label may provide the child's parental/guardian contacts, and the arrow on the right would give any secondary contact information, such as a grandparent or a neighbor.

Although the above example is related to an emergency situation, it should be understood that the identification card application can be used for many different types of information retrieval which the entity supplying the identification card might find useful. In another example, the identification card 5000 could be used to charge the student for meals under the school's meal plan.

### Education/Instruction Application

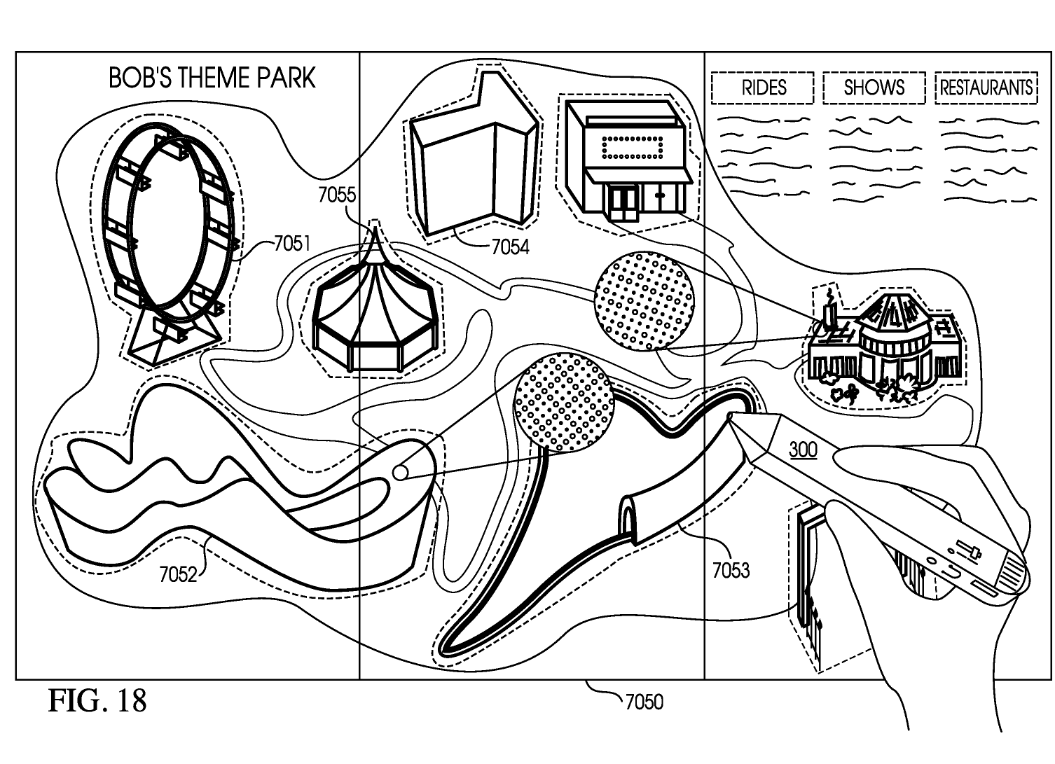

As shown in the embodiment illustrated in FIG. 16, the substrate 155 may comprise some form of instructional or educational material 6000. As already described in association with the other embodiments, the instructional material would include one or more printed codes (not visible to the human eye in FIG. 16 in accordance with the present invention) which may be associated with one or more printed regions on the instructional material. The single printed code would be repeatedly printed so as to cover the entirety of each select region.

The instructional/educational application can be developed for different mediums. The instructional material 6000 may contain no printed words, but rather may contain only figures or pictures. The printed regions which contain printed code may be in the appropriate areas of the figures or pictures. This type of medium would be ideal for instructional material 6000 wherein the user needs to memorize figures, parts of figures, or information about written words in the instructional material 6000. It should be understood that the instructional material 6000 may also be used for types of information retrieval other than those previously listed.

The user would simply touch the hand-held device 300 to the portion of the figure that the user needs to memorize. The hand-held device 300 via the audio speaker 340 would audibly state the name of the portion of the figure which is to be identified. The user could test his knowledge by comparing his answer to the actual name of the figure which has been audibly read through the audio speaker 340.

Alternatively, the instructional material 6000 may contain printed words and printed code. The printed words would be within regions of printed code as has been indicated in other embodiments. As indicated in previous embodiments, the printed code and the printed words could be simultaneously added to the document. When the hand-held device 300 comes in contact with the printed regions, the hand-held device 300 via the audio speaker 340 would audibly read the words or phrases. This particular type of media would be ideal for situations in which the user of the instructional material needs to know how to pronounce words, for example, when a user is learning a foreign language.

The application may also utilize both of the above-mentioned features. This type of instructional material would have printed regions in the locations of both the figures/drawings and the printed words. Generally, the printed words would be listed in a legend. The user will touch the hand-held device 300 to a printed word, the printed word will be audibly read, and then the hand-held device 300 will instruct the user to find the location of the word in a figure. If the user is correct the hand-held device 300 will audibly read the printed code indicating the correctness of the selection; however if the user is incorrect the hand-held device 300 will not read the printed code and the hand-held device 300 will audibly indicate the incorrectness of the selection. For example, FIG. 16 illustrates an example of this type of instructional material. Here, the user has already touched the word on the instructional material with the hand-held device 300, and the hand-held device 300 has read the printed code 6001 and is instructing the user to find the location in the figure which represents that word. Upon finding the location in the figure, which is represented by printed region 6010, the hand-held device 300 will read the printed code and audibly indicate that the selection is correct via the audio speaker 340. Although only two words are provided in instructional material 6000 to avoid obscuring the figure, it is to be understood that the instructional material may contain a legend with many parts to find in the associated figure.

It is to be understood that any of the above-mentioned embodiments of the instructional materials may include a language change option. Along these lines it should be apparent to those having read the present specification that the device and an associated substrate may be readily used to teach foreign languages.

### Museum or Theme Park Applications

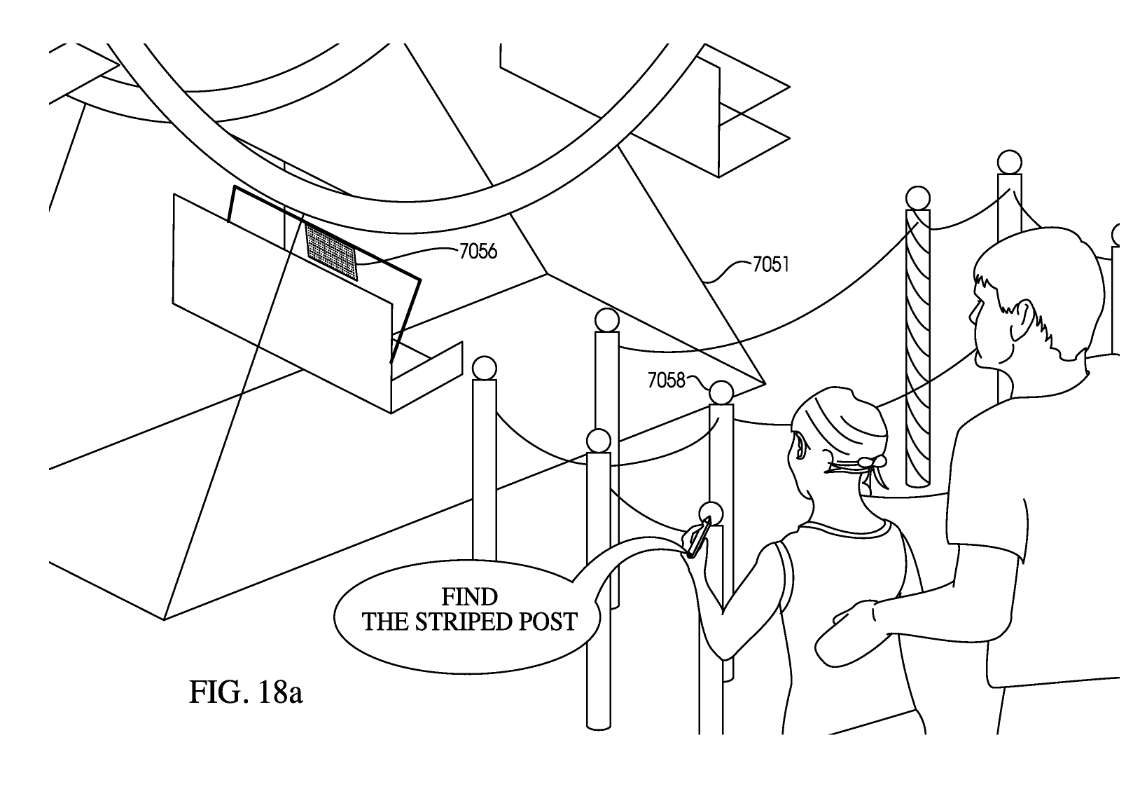

As shown in FIG. 17, the substrate 155 may comprise a display label 7000 on a display 7035 in a museum. The display label 7000 may be an intermediate substrate, in the form of an adhesive sticker as shown in FIG. 2. The adhesive sticker may have one or more layers as discussed with reference to FIG. 2. The adhesive sticker would have to be made of a material that would stand up to wear and tear, especially if it is used outdoors. Alternatively, the display label 7000 could be printed on the display itself. The display label 7000 could also be a daily or weekly replaceable type of label that is attached in some manner to the display. The attachment could be via fasteners other any other type of suitable attachment means. It is to be understood that the above-mentioned display labels 7000 are only examples, and other types of suitable display labels 7000 are to be considered potential embodiments.

As shown in FIG. 17, the display label 7000 could include at least printed regions at a language selector indicator 7001 and age appropriate description, “ages 5-8” 7002, “ages 9-11” 7003, “ages 11-15” 7004, and “adult” 7005. The user of the hand-held device 300 would select his age and language. The hand-held device 300 would then read only the printed regions of the code on the display label 7000 and audibly read the description in the appropriate age level and language for the user. It is contemplated that once the user selects a language and age, the device may be programmed to default to that language-age selection until another selection is made. As a result, it is further contemplated that the age and language selection could be provided on separate signage to avoid obscuring the other signage in the museum. It is to be understood that other printed regions associated with visible printing may be present on the display label 7000, but to avoid obscuring the figure references numerals have been withheld from the figure.

In this application the non-volatile memory 320 of the hand-held device 300 would have to be loaded with the tour information in each language and particular age group. This would be ideal for short tours wherein the amount of memory necessary would be limited. Alternatively, the hand-held device 300 could be pre-programmed by age and language, so that when the user enters the museum, he is given a hand-held device 300 which is specific to his language and age group. The hand-held device 300 would be pre-programmed so that it would only read the code on the display that corresponds to the pre-programmed information in the hand-held device 300. Therefore, all museum visitors would touch the same display label 7000 with the hand-held device 300, but depending on the programming of the hand-held device 300 the visitor would obtain his own specific tour. The downloading of the user specific information to the hand-held device 300 may be accomplished wirelessly or by wired connection. Furthermore, the non volatile memory of the hand-held device 300 could be programmed per museum visitor at the actual time of his arrival and throughout updated wirelessly throughout the tour.

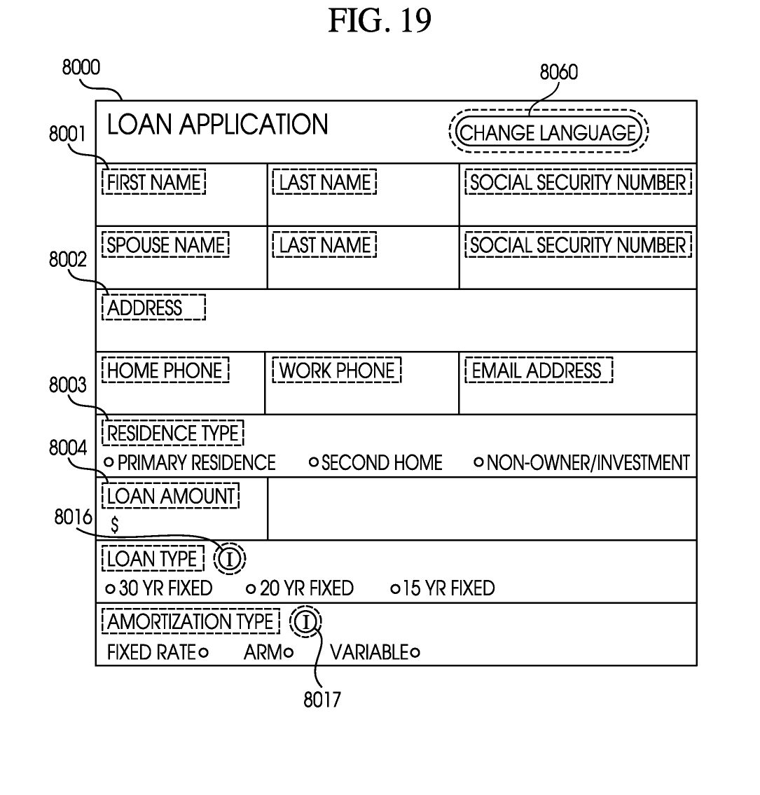

As shown in FIG. 18, the substrate 155 may be theme park map 7050. The map is a typical theme park map which may be folded and stored for use when necessary. The map contains one or more printed codes (not visible to the human eye in accordance with the present invention) which are associated with one or more printed regions on the theme park map. FIG. 18 illustrates the printed regions 7051, 7052, 7053, 7054, and 7055 on the map. Each printed region is a amusement park attraction. Within each printed region 7051, 7052, 7053, 7054, and 7055 a single printed code would be repeatedly printed so as to cover the entirety of the select region. A user will use the hand-held device 300 to read the printed code on the map. By touching the printed codes on the theme map, the hand-held device 300 will audibly provide details about the attraction to the user of the hand-held device 300.

Furthermore, the theme map may have a legend which includes information about various attractions at the theme park. For example, the legend would include the names of the various rides, restaurants, and shows. Each visible attraction name listed in the legend will also contain printed code so that when a user touches the hand-held device 300 to a specific attraction, the user will obtain additional information about that attraction. For example, the user of the hand-held device 300 may want more information regarding a show playing at one of the theaters. The user would touch the hand-held device 300 to the show's name and the hand-held device 300 may provide audible details about the show, the times, the performers, or any other relevant information. If the user touched the hand-held device 300 to a restaurant the user may audibly hear information regarding the restaurant theme, the menu, and/or the cost.

Additionally, as shown in the illustrated embodiment, the memory 320 of the hand-held device 300 may be updated in substantially real time. Since the hand-held device 300 is updated in real-time it can provide the user, for instance, information regarding wait times for the amusement park attractions. In another example, the device could provide upcoming show-times for performances and/or parades within the theme park. Additionally, the user can touch his current attraction location on the map, and move the hand-held device 300 to the attraction he would like to go to next, and the hand-held device 300 will audibly relay information relating to distance to the next attraction, the shortest route to the next attraction, and the estimated amount of travel time to the next attraction.

As shown in FIG. 18a, the hand-held device 300 can also be used to entertain guests of the amusement park while they are waiting in line for an attraction. While in queue for the attraction there may be substrates 155 which may comprise, for example, adhesive stickers on poles, walls, and other mediums containing printed codes. The substrate 155 may also comprise other types of medium depending on the requirements of the user. For example, in FIG. 18a one medium is the top of the pole 7058. The hand-held device 300 will read the printed code and audibly provide entertainment through the audio speaker 340 while theme park guests are waiting for the ride. The printed code may translate into music, a story, or some other form of entertainment which may relate to the theme of the specific attraction for which the guest of the park is in queue. The user of the hand-held device 300 will be directed to the location to which the hand-held device 300 can read the label or other type of substrate. For example, the pole might read “touch wand here” or there may be audible instructions directing the user to touch the hand-held device 300 on a particular location. For example, in FIG. 18a, the hand-held device 300 audibly instructs the user to “find the striped post.”

As shown in FIG. 18a, the hand-held device 300 can further be used to entertain guests of the amusement park while they are on an attraction. For example, substrates 155 may be found on rides in which there is not too much movement. In FIG. 18a, the attraction is a Ferris Wheel, and the substrate 155 is in the form of an adhesive sticker 7056 which is placed in front of the riders. The rider would touch their hand-held device 300 to the adhesive sticker 7056 and be provided some form of entertainment through the audio speaker 340. For example, the rider may hear about the history of Ferris Wheels or a song may play. It is to be understood that the type of entertainment provided can be varied depending on the ride and the interests of the riders.

The theme park can also choose to send the hand-held device 300 to theme park guests prior to their arrival. This would generally be sent to theme park guests who make reservations to stay at a resort on the park premises (not shown); however, other guests may also receive hand-held devices. The non-volatile memory (not shown) 320 of the hand-held device 300 may be uploaded with information about the amusement park, the specific location the guests are staying, the weather for the time of year of their reservation, any special event, any promotional deals, and, any other relevant information which may be considered important for the visitors. The hand-held device 300 may even be updated to include specific greetings for the specific individuals. This can be used to get specific individuals excited about the upcoming trip. For example, if a family is traveling to the park with young children, the theme park may send a hand-held device 300 to the family with specialized greetings for the individual children. Once the hand-held device 300 is on the theme park premises, the non-volatile memory 320 in device 300 may be updated either wirelessly or by wired connection.

It should be understood that the theme park/museum application is not limited to the examples described herein, and can be used in any similar types of settings, for instance, a zoo, an aquarium, or a carnival.

### Financial/Legal Applications

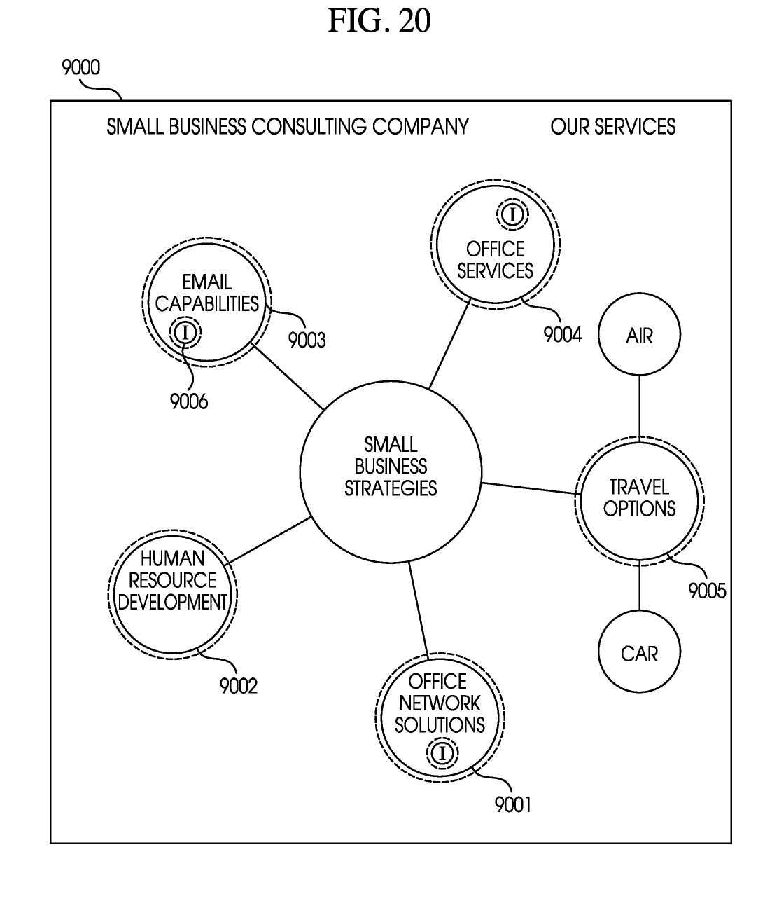

As shown in the embodiment in FIG. 19, the substrate 155 may comprise a pre-printed fillable sheet 8000, which has one or more printed codes not visible to the human eye associated with a respective one or more printed regions on the fillable sheet 8000. The fillable sheet could be a document that may be normally difficult to fill out, and a person filling it may need assistance in completing it. For example, the fillable sheet could comprise a tax form, a loan form, and other similar forms. In this particular embodiment of the fillable sheet 8000, the printed regions 8001, 8002, 8003, and 8004, among others not numbered, are actually bounded by visibly printed lines and/or color distinctions. Within each printed region or colored region a single printed code would be repeatedly printed so as to cover the entirety of the select region.

In many cases, the printed codes used on the fillable sheet 8000 would be set codes; however, there may be instances in which the printed code would be unique for the user of the fillable sheet 8000 or for the manufacturer of the fillable sheet 8000. For example, fillable regions such as “date”, “name” and “signature” could be set codes; however, specific information for the specific fillable sheet would be unique code which could be inserted by the group that prints the fillable sheet 8000. Moreover, the fillable sheet 8000 may contain fillable portions without regions with printed code. For example, a manufacturer of the fillable sheet 8000 may choose to have only printed regions containing printed codes in those fillable portions that generally require additional explanation or information.

The unique printed codes may be printed on the substrate 155 at the same time that any visible information is printed on the fillable sheet 8000. Some of the printed codes may be pre-printed on the substrate 155, particularly in the example where the information is not variable such as name 8001. It should also be understood that some of the visible printing may also be pre-printed such as the lines that divide some of the coded regions, the information symbols 8016 and 8017 and the change language icon 8060.

The interaction between the fillable sheet 8000 and the hand-held device 300 follows similar to as would be expected by those of ordinary skill in the art having now read the present disclosure. For instance, touching the hand-held device 300 to printed region 8001 would result “insert name” being audibly read by the hand-held device 300 through its audio speaker 340. Similarly, the hand-held device 300 would audibly read other information depending on which area the user touches. Moreover, the user could touch the hand-held device 300 to the information symbols 8016 and 8017 to hear more information regarding the specific entry line. For example, in FIG. 19, touching the information symbol 8016 next to “loan type” would provide the user with more specific details about the meaning and differences among the listed “loan types”.

### Marketing Applications

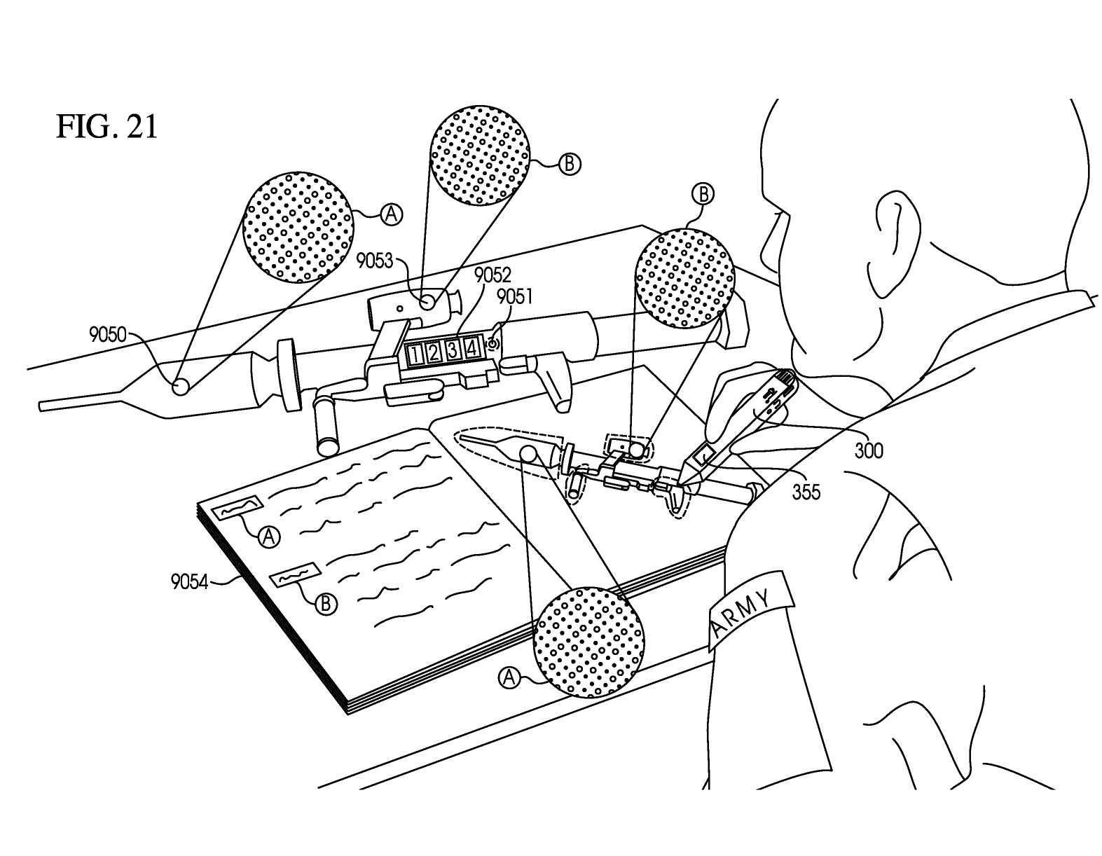

As shown in the embodiment in FIG. 20, the substrate 155 may comprise a marketing document 9000, which has one or more printed codes not visible to the human eye associated with a respective one or more printed regions on the marketing document 9000. When the marketing document 9000 is created, it would include the invisible printed code in any region where the company would like the option to provide additional information about a product. For example depicted in FIG. 20, 9001, 9002, 9003, 9004, and 9005 are printed regions containing printed code for the corresponding printed regions. Alternatively, the company could use information symbols containing regions of printed code. As shown in FIG. 20, 9006 is an information symbol. The company may also choose to use both invisible code and the information symbols. This option would allow the user to obtain overall information regarding a topic as well as more detailed information if the information symbol was touched.

The interaction between the marketing document 9000 and the hand-held device 300 follows similar to as would be expected by one of ordinary skill in the art having now read the present disclosure. As indicated in the applications described above, touching the hand-held device 300 to an information symbol would result in the audible reading of additional information regarding the product which the hand-held device user wants more information. Similarly, the hand-held device 300 would read aloud other information depending on which area the user touches. Additionally, after touching the information symbol, the user may be instructed to touch another area for further information in a specific topic. For example, in FIG. 20, the user of the hand-held device 300 may touch the information symbol 9006 with the hand-held device 300 which will then provide information regarding “email capabilities” and be directed to push the information symbol associated with “office services.” A product of this nature would allow a company to eliminate a large amount of marketing material because more information could be obtained from one document.

It should be understood that the marketing document 9000′ could contain other types of visibly printed shapes, colors, and lines depending on the usage of the marketing document 9000. Additionally, the marketing document 9000 could include additional printed regions as is indicated in FIG. 20, but not given reference numbers to avoid obscuring the figure. As indicated in previous discussions of other above-mentioned applications, these “regions” containing the printed code are not actually visible to the naked eye in operation.

It should also be understood that some of the visible printing on marketing document 9000 may also be included such as a change language icon which could be a pre-printed symbol.

### Military/Training Applications

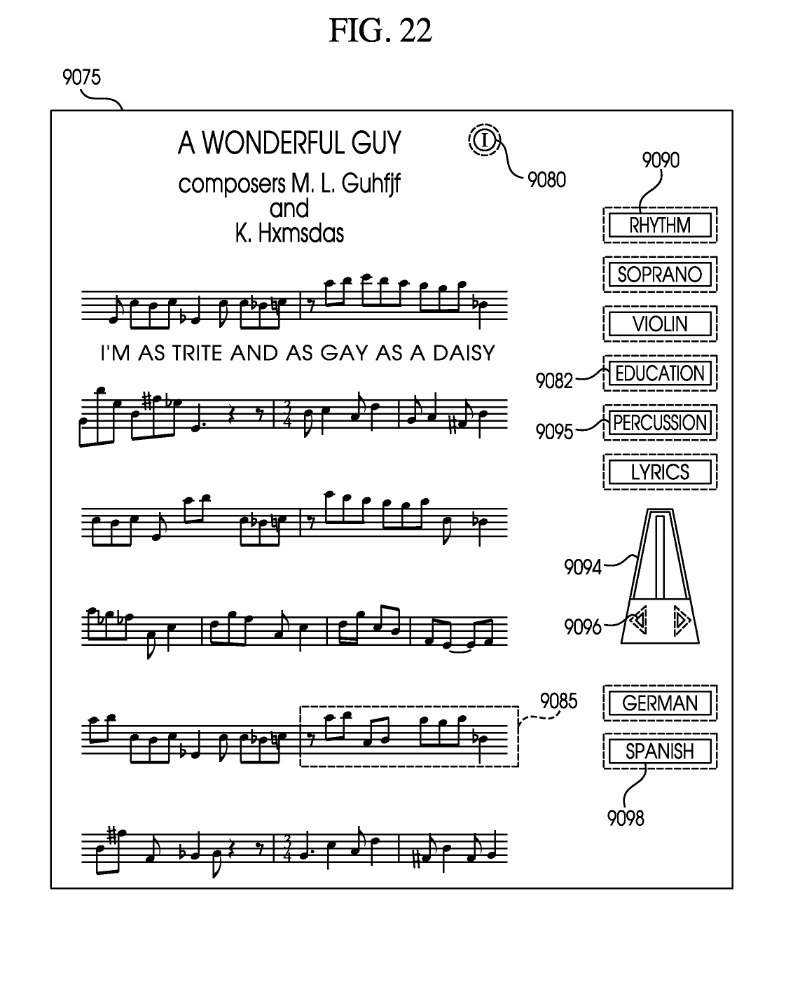

As shown in FIG. 21, in another embodiment of the invention the substrate 155 can be a label 9050 which is placed on various types of equipment. It is also contemplated that printed code may be printed directly on components, but we will discuss the label embodiment with the understanding that direct printing could be used instead or in addition to the label 9050. As discussed above, the label may be in the form of an adhesive sticker, which may have varying layers as described in FIG. 2. The label 9050 must be made of a material which will stand up to aggressive wear and tear; however, the label 9050 may be replaceable so that when it is worn, it may be replaced by an identical label. On the label 9050 is printed code which is not visible to the human eye and which is associated with a respective one or more printed regions. A single printed code would be repeatedly printed so as to cover the entirety of the select region.

The label 9050 would contain, for example, instructional printed code so that when a hand-held device 300 reads the printed code via the audio speaker 340 it will audibly instruct the user how to use the equipment. Therefore, each label 9050 which has printed code is specific to a specific piece of equipment. Moreover, if there are various parts of the specific pieces of equipment the labels must, be specific to the specific pieces. This type of label would prove to be very helpful in areas where individuals are required to use many different pieces of highly technical equipment. If a user is unsure how to use a piece of equipment he could easily obtain instructions without being required to read a manual or inadvertently use the equipment incorrectly.

As shown in FIG. 21, the user of the equipment may also receive additional information about the weapon through the use of the instruction manual 9054 which also contains printed codes. When touching the hand-held 300 on the substrate on the weapon, it may instruct the user to touch a specific region in the instruction manual 9054 which contains the printed code relating to the specific part of the weapon. For example, after touching the adhesive stickers 9050, the hand-held device may audibly instruct the user to touch the diagram in the instruction manual at region “A” or touch the text within the instruction manual at region “A”. Upon touching the hand-held device 300 to “A” the user would receive additional information about the specific weapon part. The user would receive similar instructions if he held the hand-held device to adhesive sticker 9053.

Also, as shown in FIG. 21 the hand-held device may have a biometric sensor 355, as was discussed above with respect to FIG. 5. The biometric sensor 355 may be a fingerprint reader, or biometric analysis such as a voice-analyzer or handwriting analyzer. One or more of these biometric sensors 355 may be used alone or in combination with each other and/or a password to provide some level of security for the system. For example, if a fingerprint reader is used, as shown in FIG. 21, once the user touches the hand-held device 300 and is authenticated as having permission to use the weapon, then the hand-held device 300 will work. The user can then request a passcode by touching label 9051 on the weapon with the hand-held device 300. Without the passcode the weapon will remain disabled. To enable the weapon the hand-held device will audibly provide a passcode to the weapon user after the user touches label 9051 with the hand-held device 300. The user can then enter the code into keypad 9052 on the weapon. Once the passcode is verified as being correct, the weapon will be enabled. The passcode will reset in a few seconds so that if the user does not enter the passcode immediately. If the passcode resets, the user will again have to authenticate he has permission to use the hand-held device 300 by touching the biometric sensor, then he will be required to get a passcode to use the weapon, again by touching the hand-held device to label 9051. This double layer of security may be desirable in the use of some weapons.

It is to be understood that the above example is only one embodiment of the military/training application. This application, for example, may be applied to military vehicles, aircraft systems, marine systems, and large equipment or systems, as well as to other hand-held equipment or systems.

### Music and Entertainment Applications

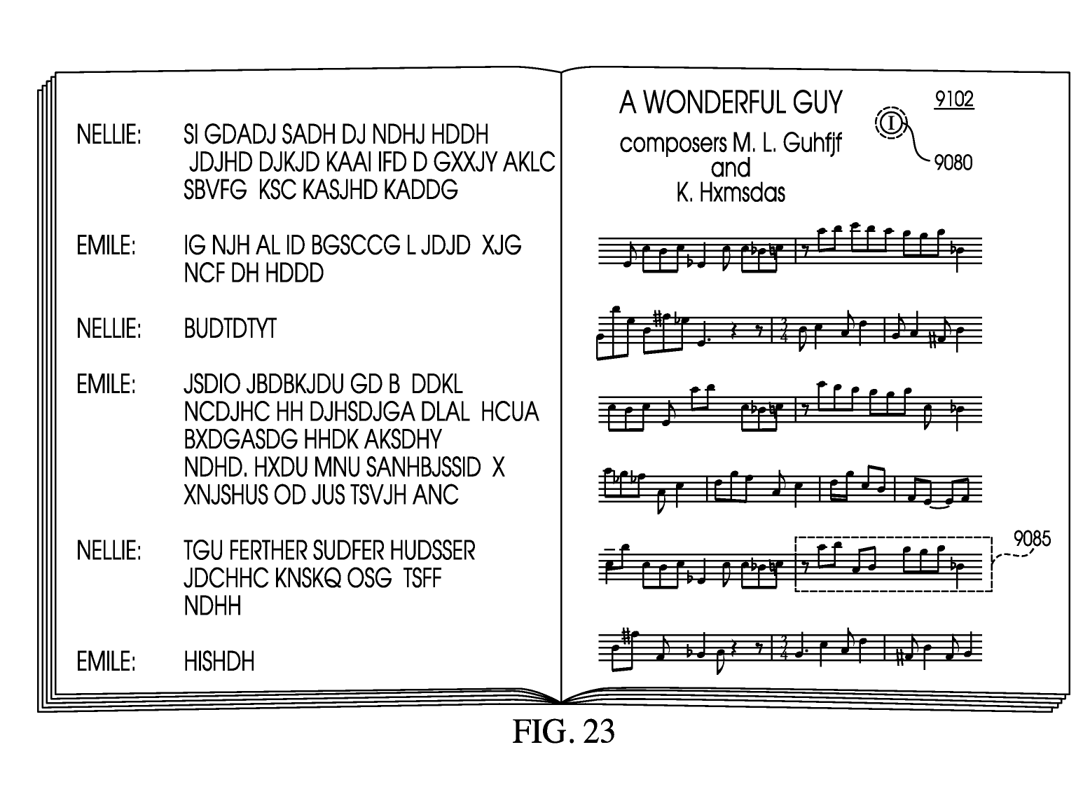

In another embodiment of the invention the substrate 155 may be a piece of sheet music 9075, which has one or more printed codes not visible to the human eye associated with a respective one or more printed regions on the sheet music 9075. As shown in FIG. 22, the sheet music may have a information symbol 9080 which contains printed code and when touched by the hand-held device 300 information regarding the composition, the composer, the music time period, and various other types of information will be audibly read through the audio speaker 340. The sheet music 9075 may be any type of score, including a full orchestra score. Each bar of the music sheet may contain printed code in a printed region surrounding the specific bar that codes specifically for the music within that bar. For example, in FIG. 22, bar 9085 contains invisible printed code which codes for the music in that bar.

It should be understood that the music sheet 9075 illustrated in FIG. 22 contains a printed regions around each bar as is indicated in bar 9085, but not given reference numbers or lines indicating printed regions to avoid obscuring the figure. As indicated in previous discussions of other above-mentioned applications, these “regions” containing the printed code are not actually visible to the naked eye in operation.

The sheet music 9075 may also enable the user to choose the option to hear only the rhythm, a specific voice range (i.e. soprano), a specific instrumental portion (e.g., violin or cello), the chorus and many options. For example, the sheet music may be from the song “A Wonderful Guy” from South Pacific, and the user could have the option of only hearing Nellie's voice, even when she is singing with the chorus. And vice versa, the user may select an option to play all instruments except Nellie's voice so the user can practice singing Nellie's part with the instruments.

Specifically, as another example, by touching the hand-held device 300 to a specific symbol, for example, “rhythm” 9090 on the music sheet, the user of the hand-held device 300 can then touch each bar of the sheet music and hear only the rhythm for each bar the user touches. The hand-held device 300 is prompted to only read the rhythm after the hand-held device 300 is touched to the “rhythm” 9090 printed region. Therefore, when the hand-held device 300 touches a bar the hand-held device 300 only reads the printed code specific for “rhythm” and audibly reads only the rhythm via the audio speaker 340. Subsequently, the user can then touch another specific symbol, for example “woodwinds” 9095 on the sheet-music, and the user of the hand-held device 300 can touch the bar and hear only the woodwinds in the entire musical composition or if so selected and enabled, bar-by-bar, rift-by-rift or movement-by-movement.

Moreover, the sheet music will also have other options, for example, as shown in FIG. 22, the user may touch the printed region of the Spanish language box 9098 and any audible words associated the sheet music (e.g. lyrics and an explanation of the song and composer) will be heard in Spanish. The sheet music can include various language options. This embodiment would be ideal for students learning songs in other languages. For example, high school or college students who perform a song in a foreign language must learn the language prior to performing the song, and the language is normally taught by the music teacher. The present sheet music-application will allow a student to learn the song on his own.

As shown in FIG. 22, the sheet music may also have a metronome symbol 9094 which will keep time/beat for the person using the sheet music. When touched, the device 300 would audibly emit a beat like a physical metronome. The metronome would preferably change tempo when the user touches the hand-held device to the arrows of the metronome. For example, touching the printed region around arrow will cause the metronome to decrease its beat.

Further, as shown in FIG. 22, the sheet music may also have a box 9082 for “education.” Upon touching the education box 9082 with the hand-held device 300, the user can then touch the hand-held device to notes, bars of music, rest symbols, and anything other object on the sheet music and the user will audibly hear information regarding whatever was touched. For example, if a user touched a rest symbol, information regarding the meaning of the rest symbol would be audibly read to the user.

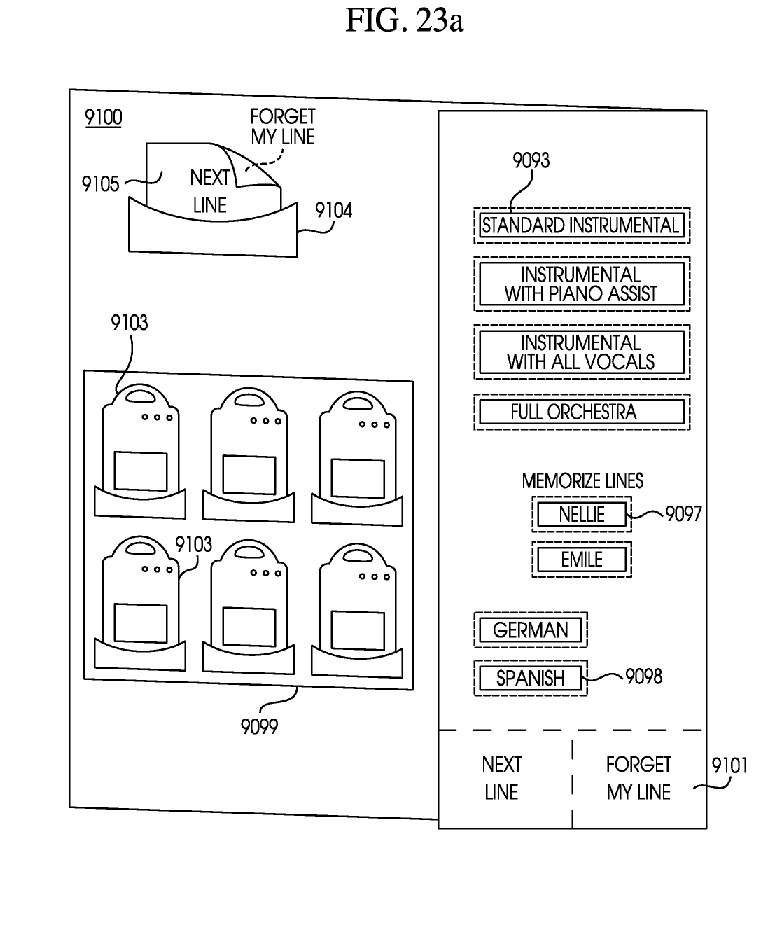

As shown in FIG. 23, the substrate may also be a musical script with lyrics 9102. The musical script with lyrics 9102 would include everything a normal musical script would include such as each song and each of the actor's lines. The script with lyrics 9102 would include printed codes which are not visible to the human eye. The script with lyrics 9102 is read with the hand-held device 300. so, for example, a user touching a segment of the script would hear the physically associated dialog.

As shown in FIG. 23a, the musical script with lyrics 9102 may include a cover 9100 which includes similar commands to that on the sheet music 9075. The cover 9100 may have printed code regions such as 9093 which is “standard instrumental” to cause the device to play only the instrumental music associated with a piece of music when selected, 9097 which is “Nellie” to help the character Nellie memorize lines, and 9098 which is the change language icon “Spanish”. Each of these printed regions contains a unique printed code. Also, the cover 9100 may also contain other visible printed regions and other printed code regions which are not indicated in FIG. 23a to avoid obscuring the figure.

So in this manner, the device and system help in the memorization of the musical script (and even just a dramatic script). By touching “Nellie” 9097 with the hand-held device 300, the hand-held device will only read the lines of characters other than Nellie. Therefore, a person could memorize lines without the help of another individual. Once “Nellie” has completed her line she may touch the hand-held device to one of the line cards 9105 which may be portable discreet cards that may be stored in the inside cover 9100 in the insert 9104 when not in use. The line cards 9105 have two sides with specific printed code on each side. One side of the line card 9105 has the code for “next line” which directs the hand-held device 300 to audibly read the next character line which is not Nellie's line. The opposite of the line card 9105 has the codes for “forgot my line” which prompts the hand-held device 300 to audibly hint “Nellie” as to her forgotten line. With the portable card, “Nellie” can walk through the staging of the play while reciting her lines and being prompted by the device as to the other actors' lines (and even her own lines).

As is shown in FIG. 23a, the inside cover 9100 also include a packet 9099 containing memory 9103 to insert in the hand-held device 300. The memory 9103 will be specific for the specific musical script with lyrics. Alternatively, the cover 9100 may include a packet containing a CD-ROM which contains the downloadable versions of the script and lyrics.

As shown in FIG. 23a, the cover 9100 may also include alternative detachable line cards 9101. The alternative line cards 9101 are preferably used if the line cards 9105 stored within the cover 9100 are lost. Like the line cards 9105, the line cards 9101 have two sides, each which has “next line” and “forgot my line” codes.

### Ticket Applications

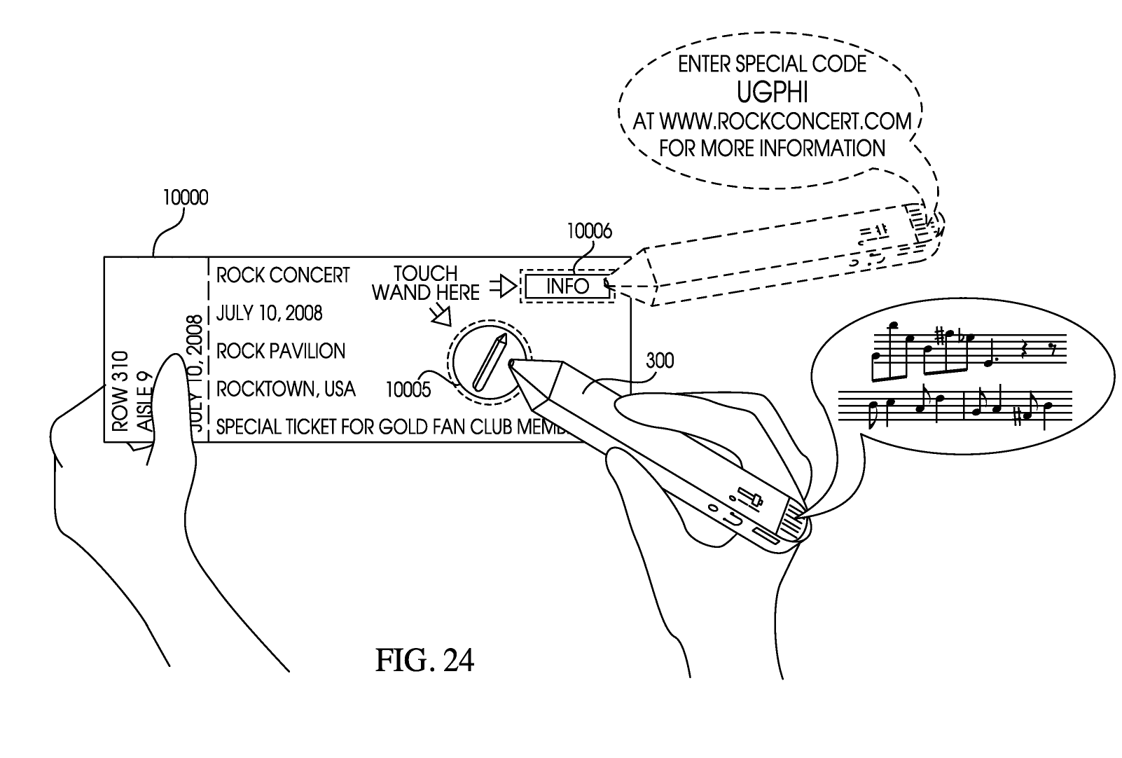

In another embodiment of the present invention, the substrate 155 comprises an entertainment ticket 10000. The ticket 10000 contains printed regions of printed code. The printed code may be printed on the tickets when the tickets are printed, or the printed code may be added to tickets at a later time. The printed code is associated with visible printed areas on the ticket. As shown in FIG. 24, for example, the ticket may have a printed area 10005 instructing the user to touch the hand-held device 300 to the region which contains printed code which when touched by the hand-held device 300 will provide a snippet of a song from the artist for which the ticket has been purchased.

Furthermore, by touching another area of the ticket containing printed code with the hand-held device 300, the ticket holder may be instructed to obtain other information on a website regarding the venue, the concert, the back stage pass option, or any other information which may be deemed relevant. For example, in FIG. 24, the printed code at “information” 10006 is detected by the hand-held device 300 and the hand-held device audibly instructs the user to access a website for additional information.

The hand-held device 300 may be provided with the ticket, or it may be provided to a specific group of ticket holders. For example, particular fans in fan clubs may receive the hand-held devices 300 with the fan club membership.

It should be understood that the concert ticket is only one example of an embodiment of the ticket application. The ticket application may be used for other purposes in any industry which provides ticketing options.

The foregoing description and drawings merely explain and illustrate the invention and the invention is not limited thereto. While the specification in this invention is described in relation to certain implementation or embodiments, many details are set forth for the purpose of illustration. Thus, the foregoing merely illustrates the principles of the invention. For example, the invention may have other specific forms without departing from its spirit or essential characteristic. The described arrangements are illustrative and not restrictive. To those skilled in the art, the invention is susceptible to additional implementations or embodiments and certain of these details described in this application may be varied considerably without departing from the basic principles of the invention. It will thus be appreciated that those skilled in the art will be able to devise various arrangements which, although not explicitly described or shown herein, embody the principles of the invention and, thus, within its scope and spirit.

What is claimed is:

1. An information system for use in information management for musical and theatrical entertainment comprising:
an electronically-accessible data record, including a performance element;
a substrate having thereon one or more printed codes practically imperceptible to a human being; and
a device having an optical reader capable of reading a selected one of the one or more printed codes on the substrate, non-volatile memory and a controller, the device further having means for providing humanly perceptible feedback, the non-volatile memory storing the performance element.

2. The invention according to claim 1 wherein at least one of the one or more printed codes are printed on the substrate.

3. The invention according to claim 2 wherein the substrate has pre-printed material that is visible to the naked eye.

4. The invention according to claim 3 wherein one of the one or more printed codes is in substantial registration with at least some of the visible pre-printed material.

5. The invention according to claim 1 wherein the one or more printed codes are printed on a printable layer of an intermediate substrate, the intermediate substrate further having an adhesive layer.

6. The invention according to claim 5 wherein the intermediate substrate is made of materials that do not significantly obscure the substrate.

7. The invention according to claim 6 wherein the intermediate substrate further includes a protective layer on top of the printable layer, wherein the protective layer is made of a material that does not significantly obscure the ability of the optical reader to read the printed code.

8. The invention according to claim 7 wherein the intermediate substrate is provided on a sheet with one or more additional intermediate substrates, each of the one or more additional intermediate substrates having a printable layer, an adhesive layer, and a protective layer on top of the printable layer, wherein each additional intermediate substrate is made of materials that do not significantly obscure the substrate and the protective layer is made of a material that does not significantly obscure the ability of the optical reader to read the printed code on each intermediate substrate.

9. The invention according to claim 8 wherein each of the additional intermediate substrates is a different shape than the intermediate substrate.

10. The invention according to claim 8 wherein the one or more printed codes are variably printed on the printable layer of the intermediate and additional intermediate substrates.

11. The invention according to claim 1 wherein the device further includes circuitry for updating the non-volatile memory.

12. The invention according to claim 11 wherein the circuitry for updating the non-volatile memory further includes a wired connector.

13. The invention according to claim 11 wherein the circuitry for updating the non-volatile memory further includes a first radio transceiver, the system further including a server having a second radio transceiver and a data record creation, storage and update subsystem operably connected to the second radio transceiver, the second radio transceiver being operably and selectively connected to the first radio transceiver.

14. The invention according to claim 13 wherein the device further includes means for recording data into the device.

15. The invention according to claim 14 wherein the means for recording data into the device comprises an audio microphone.

16. The invention of claim 15 wherein the substrate is a piece of sheet music and the performance element is selected from the group comprising a rhythm, a specific voice range, a specific instrument, a choir, an individual vocalist, and individual music notes.

17. The invention of claim 16 wherein the performance elements are selected from the group comprising bar by bar, rift by rift, and movement by movement.

18. The invention of claim 15 wherein the substrate is a theatrical script and the performance element is selected from the group comprising standard instrumental, piano assist, vocals, full orchestra, and theatrical dialog.

19. The invention of claim 18 wherein the electronically accessible data record includes a plurality of theatrical dialog performance elements wherein the device may be set to play the plurality of theatrical dialog performance elements in order.

20. The invention of claim 19 wherein the plurality of theatrical dialog performance elements includes first theatrical character dialog and second theatrical character dialog.

21. The device according to claim 20 wherein the device can be instructed by a printed code to stop playback immediately before playback of any dialog of the first theatrical character.

22. The device according to claim 21 wherein the device can be instructed by a next-line printed code to resume playback at the next second theatrical character dialog.

23. The device according to claim 22 wherein the next-line printed code that instructs the device to resume playback at the next second theatrical character dialog is printed on a hand-held card.

24. The device according to claim 23 wherein the device can be instructed by a forgot-my-line printed code to resume playback at the next first theatrical character dialog.

25. The device according to claim 24 wherein the forgot-my-line printed code that instructs the device to resume playback at the next first theatrical character dialog is printed on the hand-held card on the opposite side of the next-line printed code that instructs the device to resume playback at the next second theatrical character dialog is printed on a hand-held card.

26. The device according to claim 25 wherein the hand-held card has visibly printed thereon next-line and forgot-my-line in association with the respective next-line printed code and the forgot-my-line printed code.

27. The device according to claim 21 wherein the device can be instructed by a printed code to resume playback at the next first theatrical character dialog.

28. The device according to claim 27 wherein the printed code that instructs the device to resume playback at the next first theatrical character dialog is printed on a hand-held card.
